(19) United States
(12) Patent Application Publication
(10) Pub. No.: US 2016/0025371 A1
(43) Pub. Date: Jan. 28, 2016

(54) DUCT LINER

(71) Applicant: Owens Corning Intellectual Capital, LLC, Toledo, OH (US)

(72) Inventors: Jerry M. Parks, Granville, OH (US); Neil Hettler, Granville, OH (US); Weigang Qi, Westerville, OH (US); William Kunkler, Heath, OH (US)

(21) Appl. No.: 14/751,338

(22) Filed: Jun. 26, 2015

Related U.S. Application Data
(62) Division of application No. 13/764,920, filed on Feb. 12, 2013, now abandoned.
(60) Provisional application No. 61/641,492, filed on May 2, 2012.

(51) Int. Cl. F24F 13/02; F16L 59/02; F16L 9/21

(52) U.S. Cl. CPC F24F 13/0263; F16L 9/21; F16L 59/029; F24F 13/0281

(57) ABSTRACT

A duct liner includes an insulation layer and a facing. The insulation layer having a first edge surface, a second edge surface that is spaced apart from the first edge surface, and a first and second face surfaces that extend from the first edge surface to the second edge surface. The facing is disposed on the first face surface, such that the first face surface is entirely covered by the facing. The facing is disposed on the first and second edge surfaces, such that the first and second edge surfaces are entirely covered by the facing. Two spaced apart strips of the facing are disposed on and cover a portion of the second face surface adjacent to the first and second edge surfaces, such that a portion of the second face surface between the strips is uncovered by the facing.

### RELATED APPLICATION

The present application claims the benefit of U.S. Provision Patent Application Ser. No. 61/641,492, filed on May 2, 2012, which is incorporated herein by reference in its entirety.

### FIELD OF THE INVENTION

The present application generally relates to ducts and, more particularly, ducts that are lined with liners that enhance the acoustical and/or thermal performance of the ducts.

### BACKGROUND OF THE INVENTION

Ducts and conduits are used to convey air in building heating, ventilation, and air conditioning (HVAC) systems. Often these ducts are formed of sheet metal, and, as a result, do not possess good thermal or acoustical properties. In order to enhance these properties, the ducts are lined with a flexible or rigid thermal and sound insulating material. Duct insulation used in HVAC systems typically includes a facing layer adhered to an insulation layer. The insulation layer is often made from fiberglass. The facing material is commonly affixed to the insulation layer by an adhesive.

Some existing duct liners include coatings on the lateral edges of the duct liners. The coatings are typically sprayed onto the lateral edges. The edge coating may be a water based binder. The water based binder may be cured by applying heat energy to the duct liner.

The North American Insulation Manufacturers Association (NAIMA) publishes guidelines for the design, fabrication and installation of fibrous glass duct liners. For example, NAIMA published the third edition of the FIBROUS GLASS DUCT LINER STANDARD—Design, Fabrication and Installation Guidelines in 2002. These guidelines disclose a recommended guideline for the selection, fabrication and installation of fibrous glass duct liner insulations in sheet metal air handling ducts. Pages 19 and 22 of the 2002 guideline disclose installing a metal nosing on edges of duct liner facing the air stream when velocity exceeds 4000 FPM.

### SUMMARY

The present application discloses exemplary embodiments of a duct liner. In one exemplary embodiment, the duct liner includes an insulation layer and a facing. The insulation layer having a first edge surface, a second edge surface that is spaced apart from the first edge surface, and a first and second face surfaces that extend from the first edge surface to the second edge surface. The facing is disposed on the first face surface, such that the first face surface is entirely covered by the facing. The facing is disposed on the first and second edge surfaces, such that the first and second edge surfaces are entirely covered by the facing. Two spaced apart strips of the facing are disposed on and cover a portion of the second face surface adjacent to the first and second edge surfaces, such that a portion of the second face surface between the strips is uncovered by the facing. The duct liner can be used in a wide variety of different ducts.

### BRIEF DESCRIPTION OF THE DRAWINGS

Features and advantages of the present invention will become apparent to those of ordinary skill in the art to which the invention pertains from a reading of the following description together with the accompanying drawings, in which:

FIG. 1 is an end view of an exemplary embodiment of a duct liner;

FIG. 1A is an end view of an exemplary embodiment of a duct liner;

FIG. 2 is a perspective view of the duct liner illustrated by FIG. 1;

FIG. 2A is a perspective view of material that may be cut to form duct liners rolled onto a roll;

FIG. 3 is a perspective view of another exemplary embodiment of a duct liner;

FIGS. 4A-4C schematically illustrate an exemplary embodiment of a method of making a duct liner;

FIGS. 5A-5C schematically illustrate an exemplary embodiment of a method of making a duct liner;

FIGS. 6A-6C schematically illustrate an exemplary embodiment of a method of making a duct liner;

FIGS. 7A-7D schematically illustrate an exemplary embodiment of a method of making a duct liner;

FIGS. 8A-8D schematically illustrate an exemplary embodiment of a method of making a duct liner;

FIG. 9 is a sectional view of an exemplary embodiment of a duct assembly;

FIG. 10 is a sectional view of another exemplary embodiment of a duct assembly;

FIG. 10A is an illustration of an exemplary embodiment of a fastener holding a duct liner to a duct housing;

FIG. 10B is an illustration of an exemplary embodiment of a fastener holding a duct liner to a duct housing;

FIG. 10C is an illustration of an exemplary embodiment of a fastener holding a duct liner to a duct housing;

FIG. 10D is an illustration of an exemplary embodiment of a fastener for holding a duct liner to a duct housing;

FIG. 10E is an illustration of an exemplary embodiment of a fastener for holding a duct liner to a duct housing;

FIG. 11 is a sectional view of another exemplary embodiment of a duct assembly;

FIG. 12 is a perspective view of the duct assembly illustrated by FIG. 11;

FIGS. 13A and 13B illustrate an exemplary embodiment of a method of assembling a duct assembly;

FIG. 14 is a sectional view of an exemplary embodiment of a duct assembly;

FIG. 15 is a sectional view of another exemplary embodiment of a duct assembly;

FIG. 16 is a perspective view of the duct assembly illustrated by FIG. 15;

FIG. 17 is a sectional view of an exemplary embodiment of a duct assembly;

FIG. 18 is a sectional view of another exemplary embodiment of a duct assembly;

FIG. 19 is a perspective view of the duct assembly illustrated by FIG. 18;

FIGS. 20A and 20B illustrate an exemplary embodiment of a method of assembling a duct assembly;

FIG. 21 is a sectional view of an exemplary embodiment of a duct assembly;

FIG. 22 is a sectional view of an exemplary embodiment of a duct assembly;

FIG. 23 is a sectional view of an exemplary embodiment of a duct assembly;

FIG. 24A is a perspective view of components that form one-half of a duct assembly;

FIG. 24B is a front end view of the duct assembly components illustrated by FIG. 24A;

FIG. 24C is a top view of the duct assembly components illustrated by FIG. 24A;

FIG. 24D is a side view of the duct assembly components illustrated by FIG. 24A;

FIG. 25 is an end view of a duct assembly formed by assembling two sets of the duct assembly components illustrated by FIGS. 24A-24D;

FIG. 26A is a perspective view of components that form one-half of a duct assembly;

FIG. 26B is a front end view of the duct assembly components illustrated by FIG. 26A;

FIG. 26C is a top view of the duct assembly components illustrated by FIG. 24A;

FIG. 26D is a side view of the duct assembly components illustrated by FIG. 24A;

FIG. 27 is an end view of a duct assembly formed by assembling two sets of the duct assembly components illustrated by FIGS. 26A-26D; and

FIG. 28 is a schematic illustration of a manufacturing line for producing a wrapped insulation product.

### DETAILED DESCRIPTION OF EXEMPLARY EMBODIMENTS

Prior to discussing the various embodiments, a review of the definitions of some exemplary terms used throughout the disclosure is appropriate. Both singular and plural forms of all terms fall within each meaning:

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members or elements. “Physical communication” as used herein, includes but is not limited to connecting, affixing, joining, attaching, fixing, fastening, placing in contact two or more components, elements, assemblies, portions or parts. Physical communication between two or more components, etc., can be direct or indirect such as through the use of one or more intermediary components and may be intermittent or continuous.

In the embodiments discussed herein, the insulation arrangements of the present application are described for use with a ducts. However, the insulation arrangements of the present application may be used in a variety of different applications. The present patent application specification and drawings provide multiple embodiments of insulation arrangements and duct assemblies. Any feature or combination of features from each of the embodiments may be used with features or combinations of features of other embodiments.

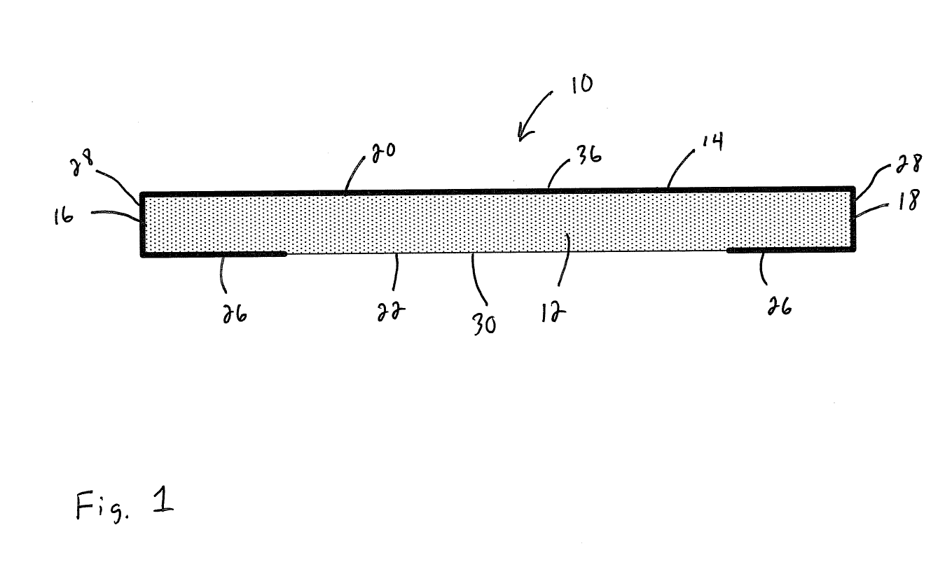

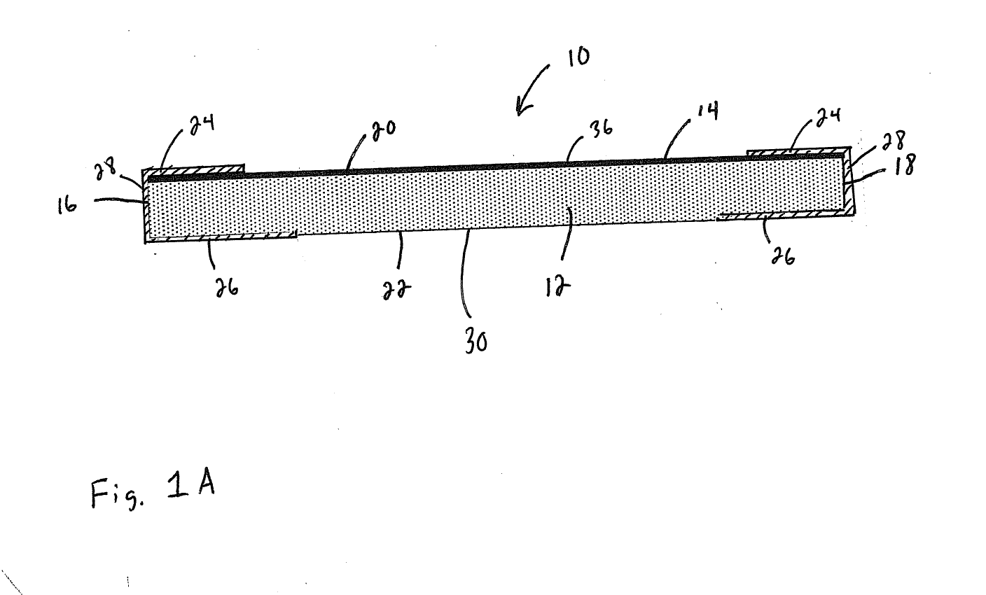

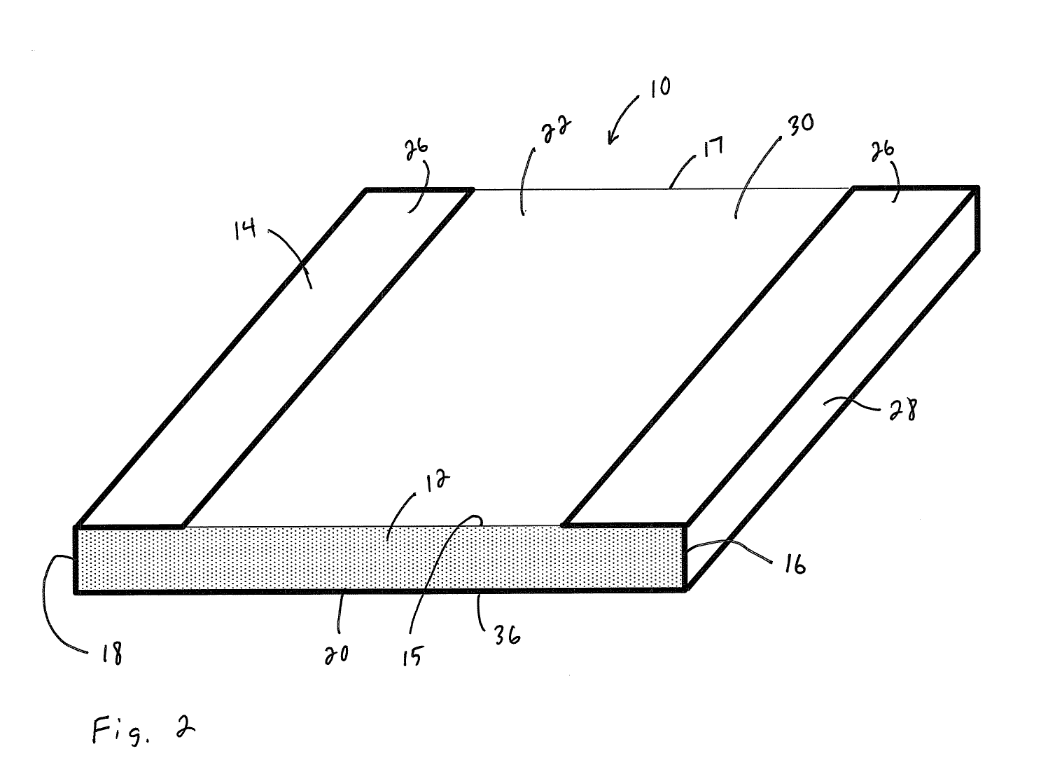

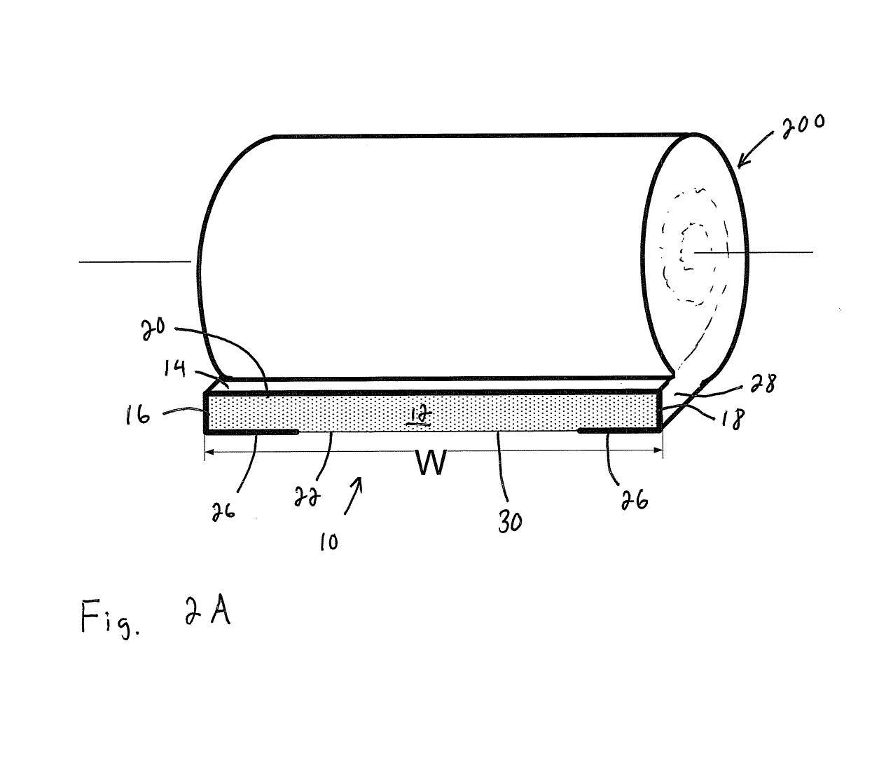

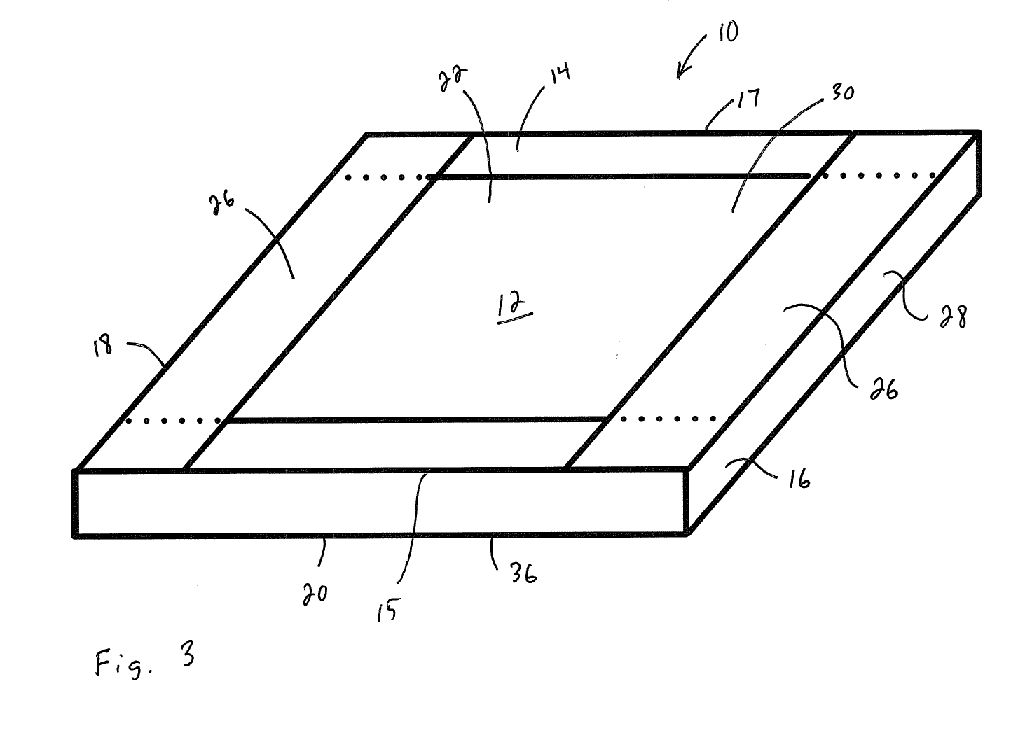

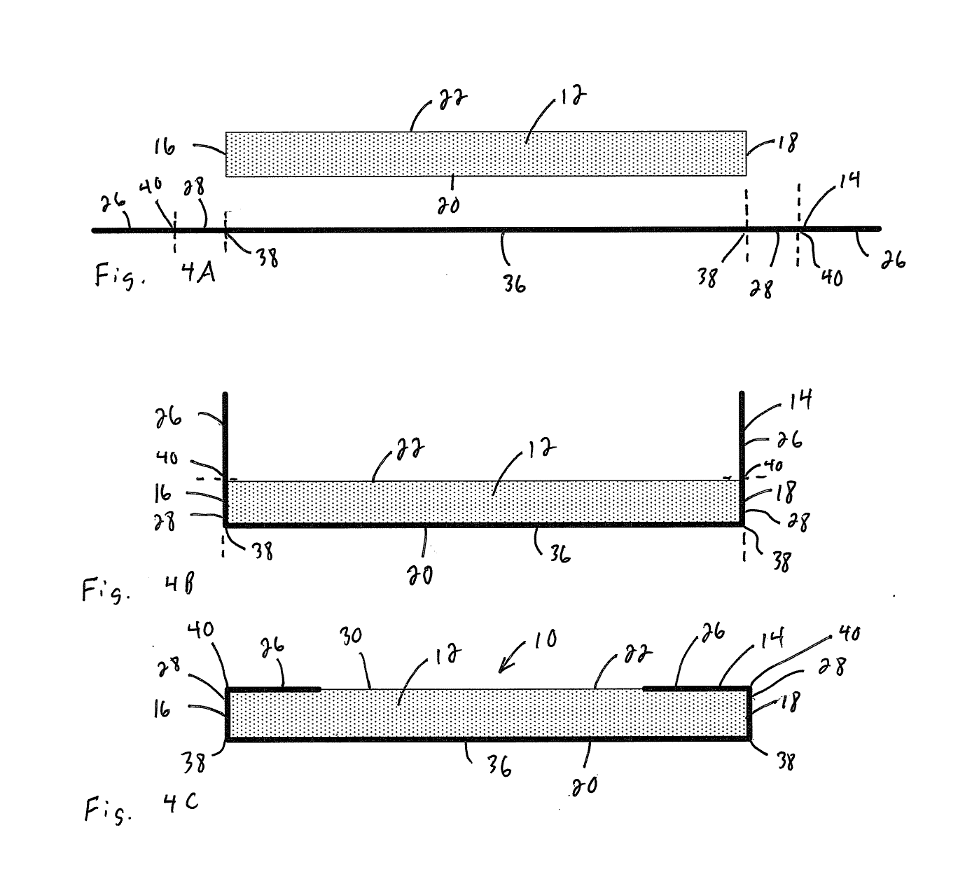

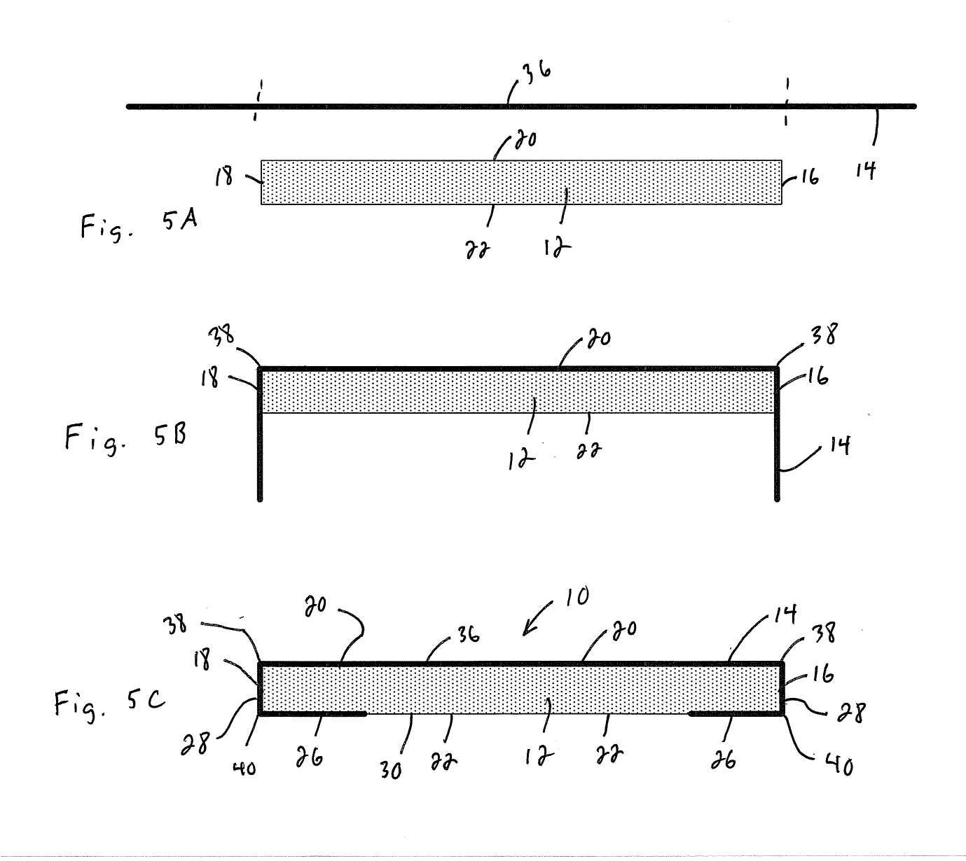

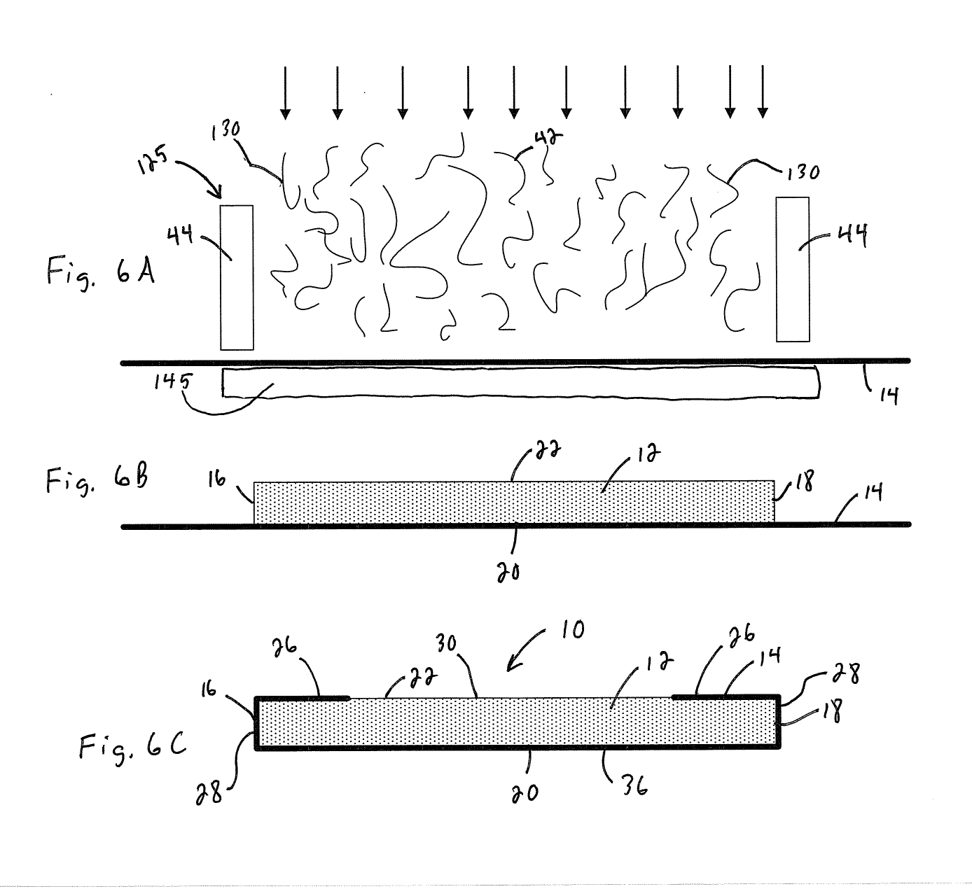

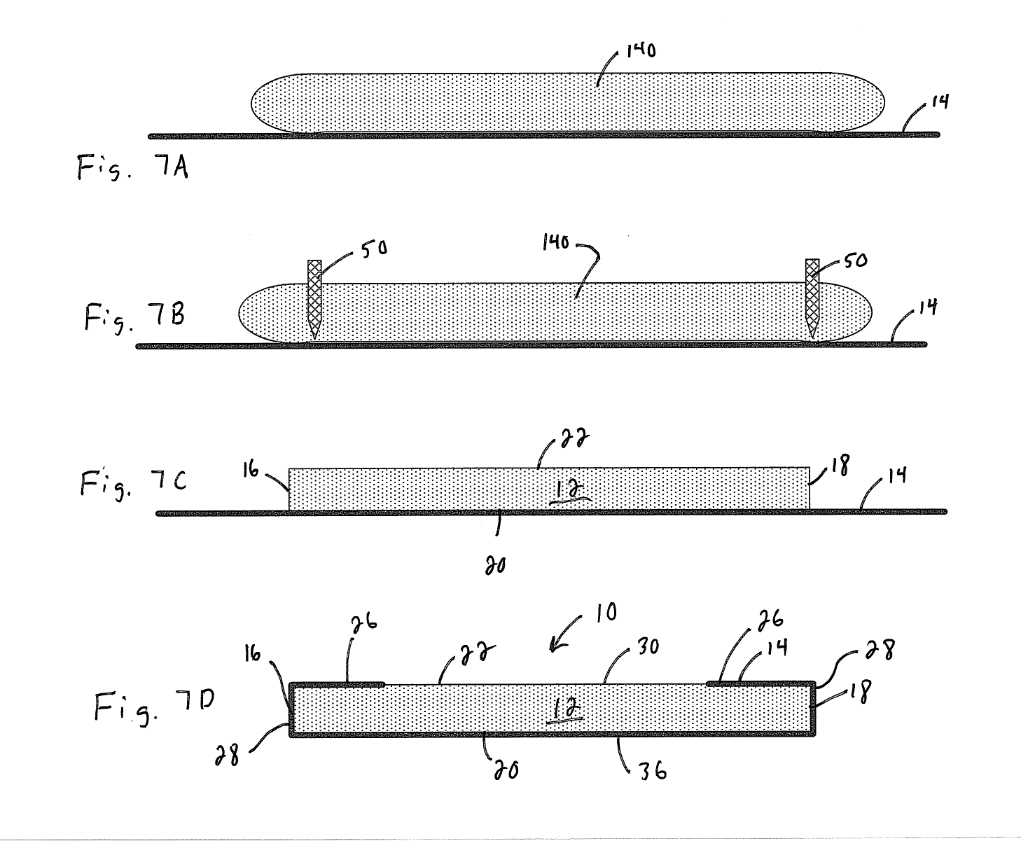

FIGS. 1 and 2 illustrate an exemplary embodiment of a duct liner 10. The illustrated duct liner 10 includes an insulation layer 12 and a facing 14. The insulation layer 12 may take a wide variety of different forms. In the illustrated embodiment, the insulation layer 12 is rectangular with a leading edge 15 and a trailing edge 17 (See FIG. 2). However, the insulation layer 12 may have any shape to accommodate the desired application the duct liner 10.

The illustrated insulation layer 12 includes a first lateral edge surface 16, and a second lateral edge surface 18 that is spaced apart from the first lateral edge surface. A first face surface 20 extends from the first lateral edge surface 16 to the second lateral edge surface 18. A second face surface 22 is opposed to and spaced apart from the first face surface 20 and also extends from the first lateral edge surface 16 to the second lateral edge surface 18.

The facing 14 is wrapped around the insulation layer 12. The facing 14 can be wrapped around the insulation layer 12 in a wide variety of different ways. The facing 14 can be wrapped around one ore both of the lateral edge surfaces 16, 18. The facing 14 can optionally be wrapped around the leading edge 15 and/or the trailing edge 17 (see FIG. 3). The facing 14 is a single piece of material in one exemplary embodiment (see FIG. 1). In another exemplary embodiment, the facing is made from multiple different pieces or sheets of material. For example, a first piece or sheet of material may cover the first face surface 20 and two strips 24 of facing material may be wrapped around the lateral edge surfaces 16, 18 of the insulation layer 12 (see FIG. 1A).

In the exemplary embodiment illustrated by FIGS. 1 and 2, the facing 14 is disposed on the first face surface 20, such that the first face surface is entirely covered by the facing 14. The facing 14 is also disposed on the first and second lateral edge surfaces 16, 18, such that the first and second edge surfaces are entirely covered by the facing. Two spaced apart strips 26 extend from the facing portions 28 that cover the first and second lateral edge surfaces 16, 18. The spaced apart strips 26 are disposed on and cover a portion of the second face surface 22 adjacent to the first and second lateral edge surfaces 16, 18. A portion 30 of the second face surface 22 between the strips 26 is not covered by the facing in the illustrated embodiment. In another exemplary embodiment, the second face surface 22 is completely covered by the facing 14. For example, the strips 26 may be sized so that one strip meets or overlaps the other strip to thereby completely cover the second face surface 22 and substantially encapsulate the insulation layer 12.

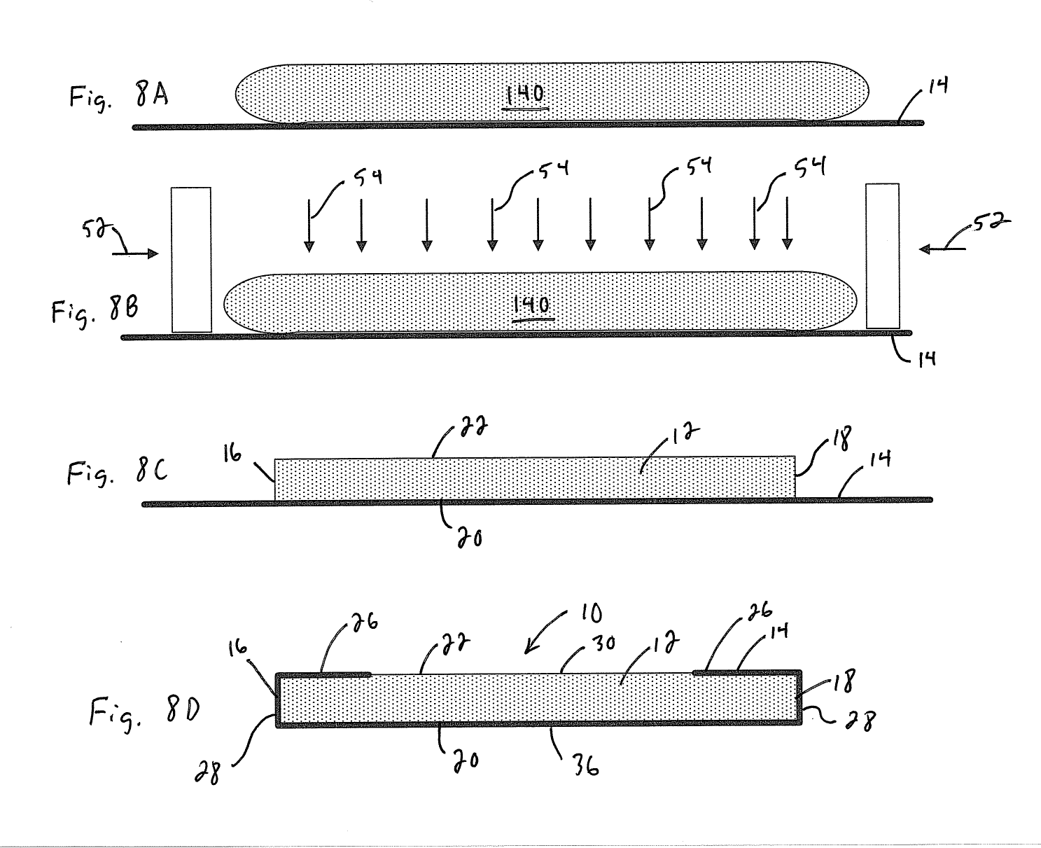

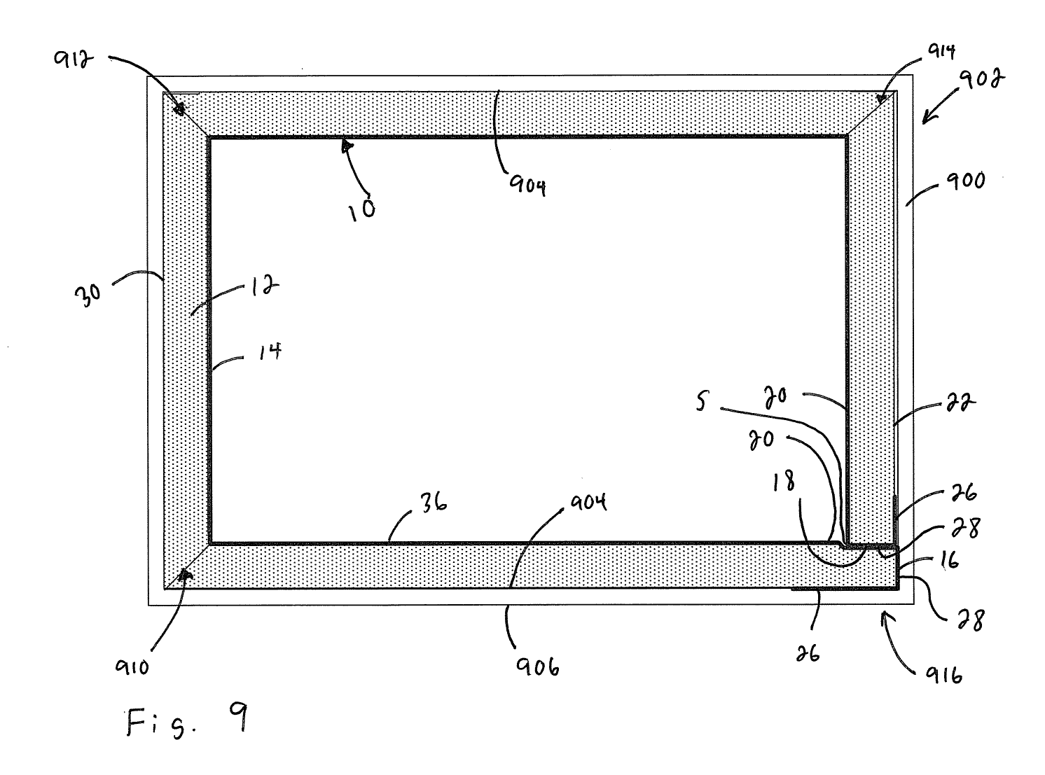

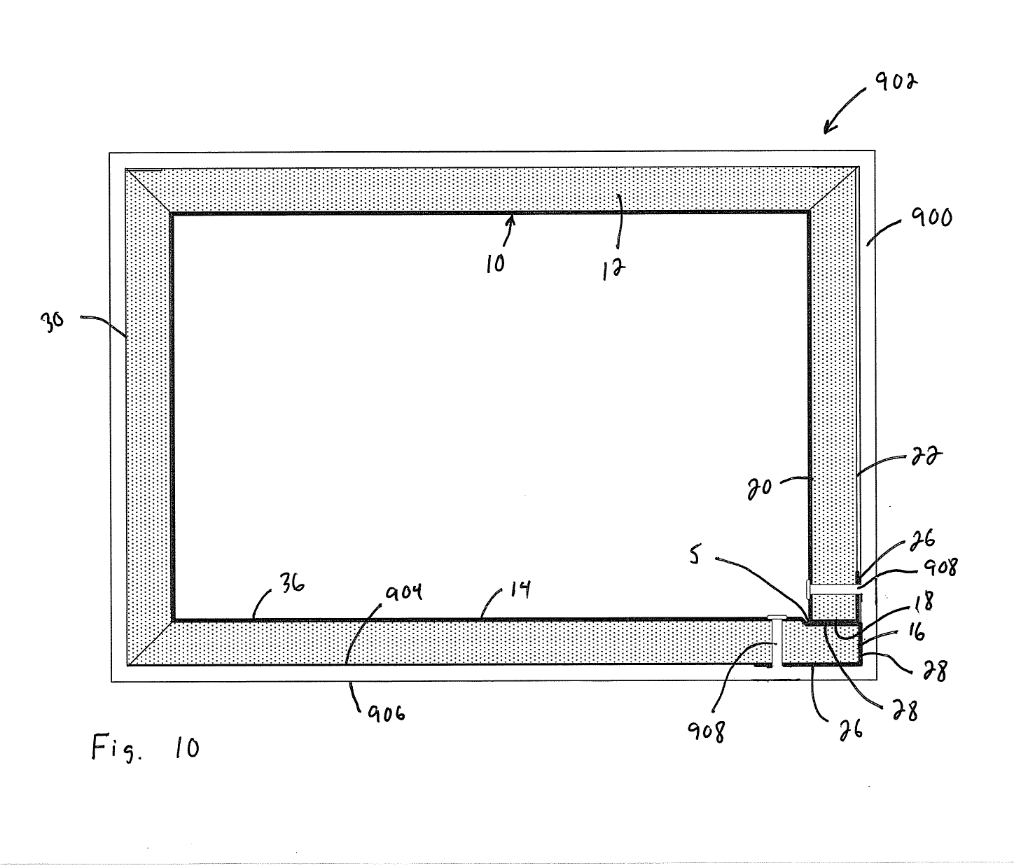

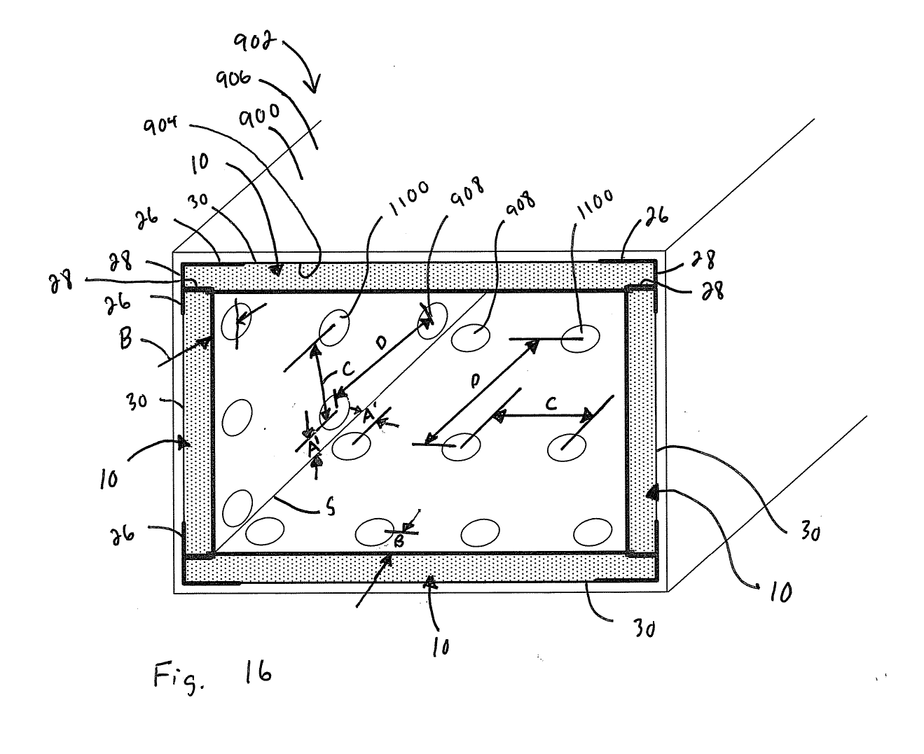

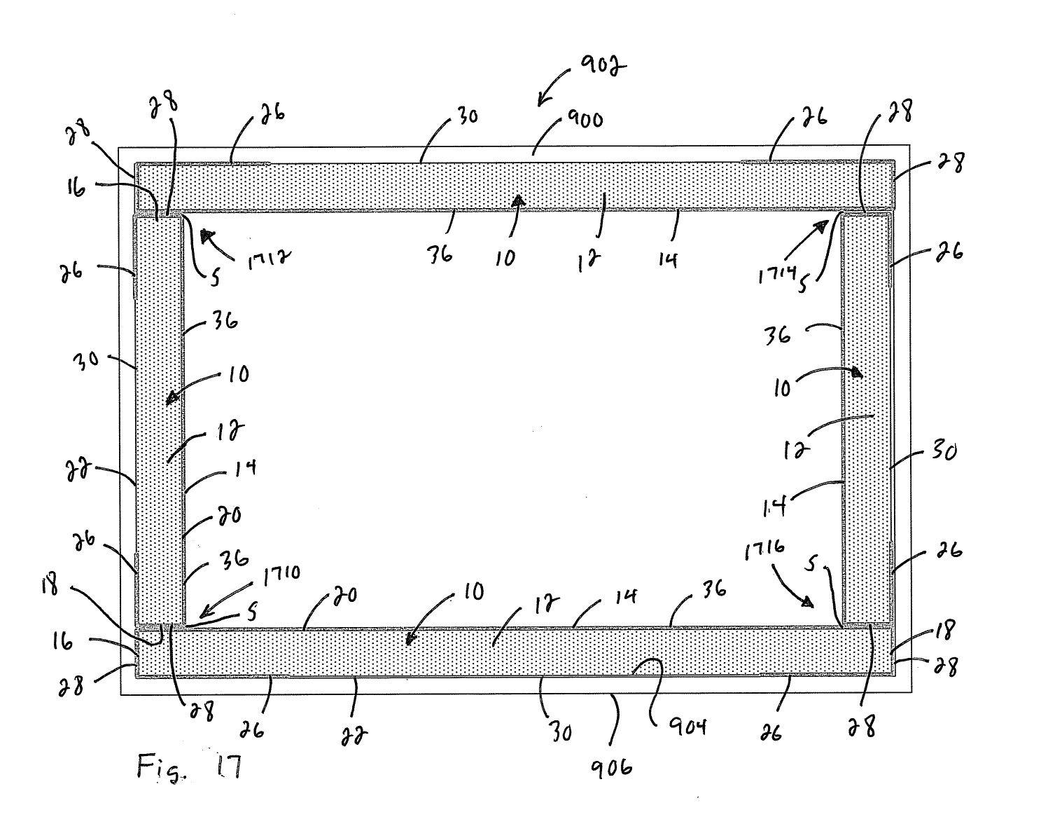

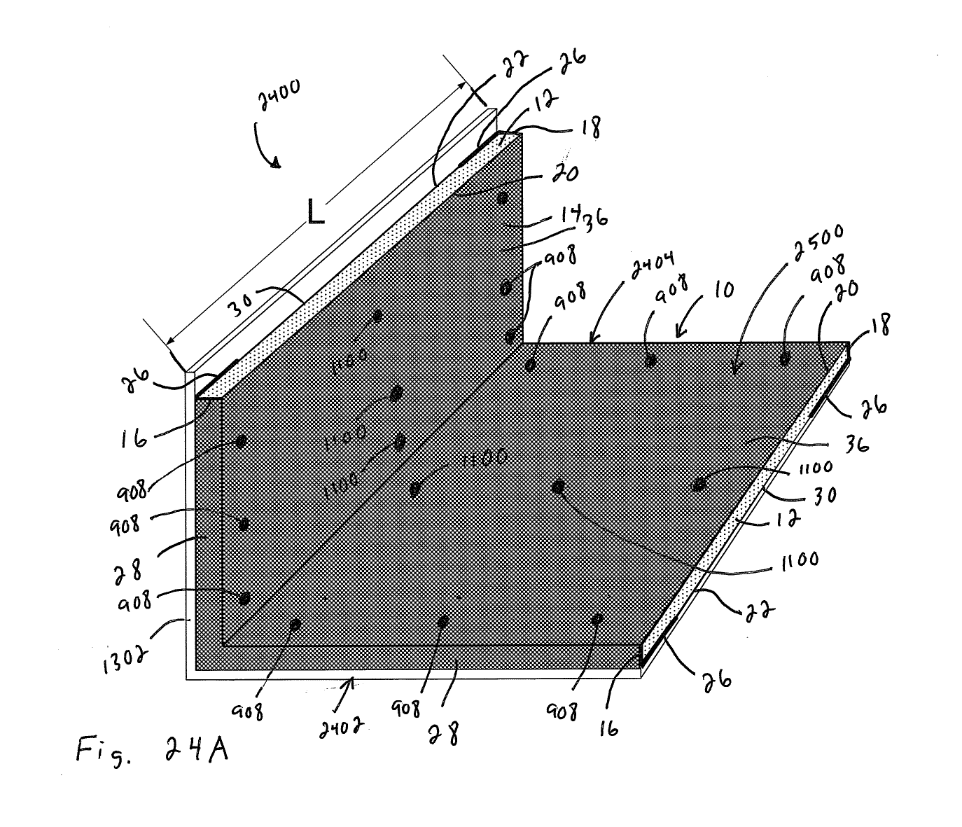

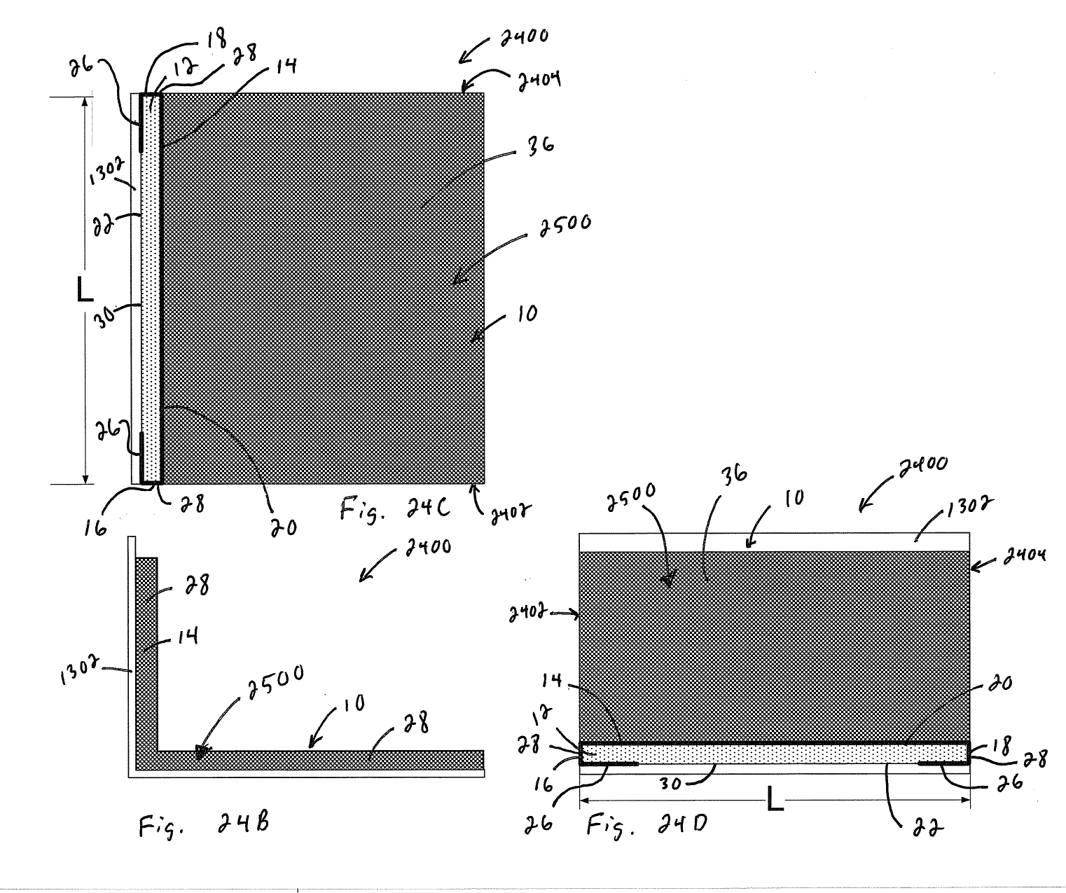

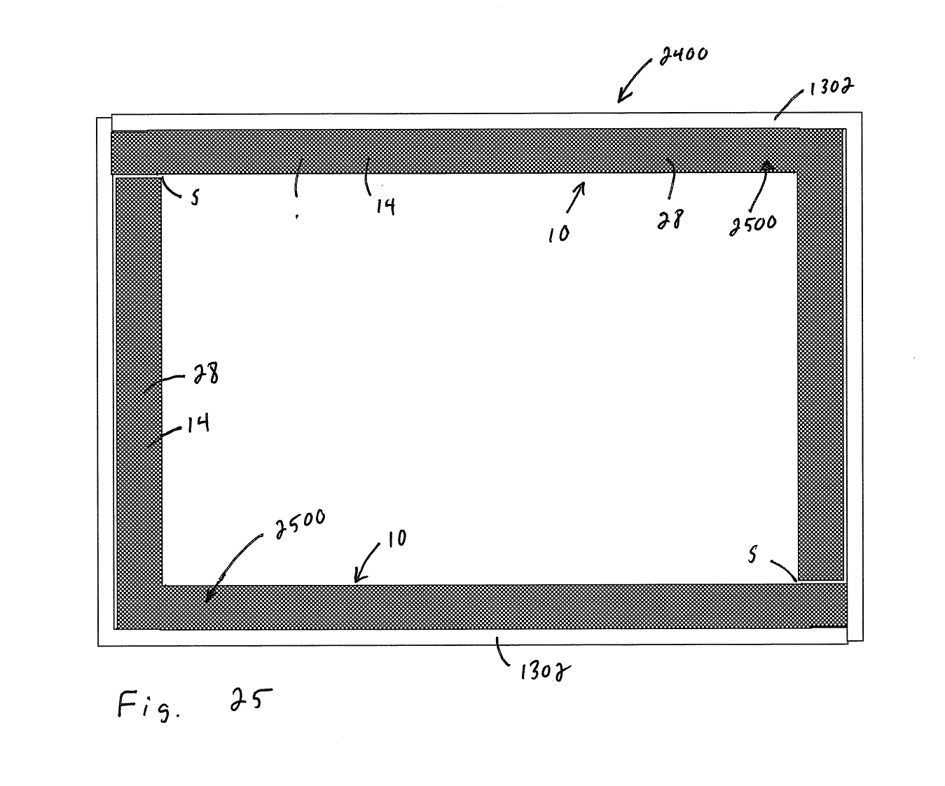

FIG. 2 illustrates the duct liner 10 in a rectangular configuration. This duct liner may be flexible for installation in a metal duct assembly or may be rigid and may be used as a duct board with or without a metal duct. In the example illustrated by FIG. 2A, the duct liner 10 is flexible, which allows the duct liner to be rolled onto a roll 200. The illustrated roll has a width W. The width W can be selected to accommodate a wide variety of different applications. Referring to FIGS. 2A and 24A for example, the width W of the duct liner roll 200 may correspond to the length L of a duct section 2400 (two of the assemblies illustrated by FIG. 24A are assembled to form a duct section 2400). By having the width W of the roll 200 correspond to the length L of the duct sections, duct sections 2400 with leading and/or trailing ends 2402, 2404 having edge surfaces 16, 18 that are entirely covered by the facing 14 can be easily manufactured. This wrapping of the edge surfaces 16, 18 at the leading and trailing edges 2402, 2404 eliminates the need to install a metal nosing on the leading edge surface 16 facing the air stream when velocity exceeds 4000 FPM. Referring to FIGS. 2A and 9 for example, the width W of the duct liner roll 200 may correspond to the interior perimeter of a duct. In this example, any requirement of forming a seal along the seam S where the ends of the duct liner ends meet is eliminated, since the edge surfaces 16, 18 are covered by the facing 14. Referring to FIGS. 2A and 13A for example, the width W of the duct liner roll 200 may correspond to the interior perimeter of a duct half. In this example, any requirement of forming seals along the seams S where the ends of the duct liner ends meet is eliminated, since the edge surfaces 16, 18 are covered by the facing 14. Referring to FIGS. 2A and 14 for example, the width W of the duct liner roll(s) 200 may correspond to duct liner panels or sides for a given duct liner size. In this example, any requirement of forming seals along the seams S where the ends of the duct liner ends meet is eliminated, since the edge surfaces 16, 18 are covered by the facing 14.

The insulation layer can be made from a wide variety of different materials and can take a wide variety of different forms. In one exemplary embodiment, the insulation layer 12 is flexible to allow the duct liner 10 to be folded, rolled, or otherwise manipulated. In another embodiment, the insulation layer 12 is rigid or board-like. In one exemplary embodiment, the insulation layer is made from a fibrous material. For example, the insulation layer may comprise fiberglass insulation, such as a bonded blanket of short glass fibers, such as the blanket used in QuietR® rotary duct liner available from Owens Corning, a bonded blanket of long glass fibers, such as the blanket used in the QuietR® textile duct liner available from Owens Corning, or organic and/or inorganic fibers in a thermosetting resin formed into flexible, semi-rigid, or rigid boards. The insulation layer 12 may be constructed from glass fibers such that the duct liner meets the physical property requirements of ASTM C 1071, Standard Specification for Thermal and Accoustical Insulation (Glass Fiber Duct Lining Material).

As noted above, the insulation layer 12 may be made from a wide variety of different materials. The materials may include glass fibers as mentioned above and can also include a wide variety of different materials. Examples of materials that the insulation layer 12 can be made from include, but are not limited to, nonwoven fiberglass and polymeric media, woven fiberglass and polymeric media, foam, including plastic foam and rubber foam, honeycomb composites, mineral wool, rock wool, ceramic fibers, glass fibers, aerogels, vermiculite, calcium silicate, fiberglass matrix, polymeric fibers, synthetic fibers, natural fibers, composite pre-forms, cellulose, wood, cloth, fabric and plastic. The insulation layer may be fire resistant, may include an antimicrobial material, and/or may be made from over 55% recycled material. As used in this application, the term “natural fiber” is meant to indicate plant fibers extracted from any part of a plant, including, but not limited to, the stein, seeds, leaves, roots, or bast. The insulation layer may be formed of organic fibers such as rayon, polyethylene, polypropylene, nylon, polyester, and mixtures thereof. Continuous fibers and/or multi-component fibers such as bicomponent or tricomponent polymer fibers may also be utilized in forming the insulation layer 12. The bicomponent fibers may be forming in a sheath-core arrangement in which the sheath is formed of first polymer fibers that substantially surround a core formed of second polymer fibers. The insulation layer 12 may be a non-woven web formed by conventional dry-laid processes or the insulation layer may be point bonded, woven, and other non-woven materials such as needled, spunbonded, or meltblown webs may be used. A binder, flame-retardants, pigments, and/or other conventional additives may also be included in the insulation layer 12. Optionally, the insulation layer 12 may be treated with a fungicide and/or bactericide either during or after manufacturing. Similarly, the waterless, thin-film adhesive may be heat bonded to a insulation layer 12 and subsequently applied to a fibrous insulation product. The insulation layer can be made from any material that provides the thermal and/or acoustical insulation properties required by the application.

When the insulation layer 12 is made from glass fibers, the insulation layer may be formed of matted glass fibers that are bonded together by a cured thermoset polymeric material. The manufacture of glass fiber insulation products may be carried out in a continuous process by fiberizing molten glass and immediately forming a fibrous glass batt on a moving conveyor. The glass may be melted in a tank (not shown) and supplied to a fiber forming device such as a fiberizing spinner. Non-limiting examples of glass fibers that may be utilized in the present invention are described in U.S. Pat. No. 6,527,014 to Aubourg; U.S. Pat. No. 5,932,499 to Xu et al.; U.S. Pat. No. 5,523,264 to Mattison; and U.S. Pat. No. 5,055,428 to Porter, the contents of which are expressly incorporated by reference in their entirety. The glass fibers, are sprayed with an aqueous binder composition. Although any conventional binder such as phenol-formaldehyde and urea-formaldehyde may be used, the binder is desirably a low formaldehyde binder composition, such as a polycarboxylic based binder, a polyaciylic acid glycerol (PAG) binder, or a polyaciylic acid triethanolamine (PAT binder). Suitable polycarboxy binder compositions for use in the instant invention include a polycarboxy polymer, a crosslinking agent, and, optionally, a catalyst. Such binders arc known for use in connection with rotary fiberglass insulation. Examples of such binder technology are found in U.S. Pat. No. 5,318,990 to Straus; U.S. Pat. No. 5,340,868 to Straus et al.; U.S. Pat. No. 5,661,213 to Arkens et al.; U.S. Pat. No. 6,274,661 to Chen et al.; U.S. Pat. No. 6,699,945 to Chen et al; and U.S. Pat. No. 6,884,849 to Chen et al., each of which is expressly incorporated entirely by reference. The binder may be present in an amount from about 2% to about 25% by weight of the total product, and preferably from about 5% to about 20% by weight of the total product, and most preferably from about 10% to about 18% by weight of the total product.

The facing 14 may take a wide variety of different forms. The facing 14 may be a single sheet of material or several layers of material. The facing my include multiple overlaying sections of material as illustrated by FIG. 1A. Further, portions of the illustrated facings 14 may be removed. For example, one of the lateral edges 16, 18 may be covered with the facing 14, while the other lateral edge is not covered by the facing. Referring to FIGS. 4A-4C, the facing 14 may be pre-folded such that the facing includes a predefined central portion 36 that covers the first face surface 20, a pair of predefined edge covering portions 28 on opposite sides of the predefined central portion 36, and the pair of strips 26 are predefined and extend from the pair of predefined edge covering portions 28.

The facing 14 may be made from a wide variety of different materials. For example, the facing 14 may comprise nonwoven fiberglass and polymeric media, woven fiberglass and polymeric media, sheathing materials, such as sheathing films made from polymeric materials, scrim, cloth, fabric, tapes kraft paper or material, and fiberglass reinforced kraft paper (FRK). The facing may be an FRK vapor retarder facing that is used on QuietR® duct board available from Owens Corning. The facing 14 may be black, high density, durable glass mat facing that is used on the QuietR® Rotary Duct Liner or QuietR® Textile Duct Liner available from Owens Corning. The facing may be fire resistant, may provide a cleanable surface, may include an antimicrobial material, and/or may be made from over 55% recycled material. The facing may be porous. Any material that reduces airflow resistance (as compared to the airflow resistance of the uncovered insulation layer 12), that isolates that insulation layer 12 from airflow, and/or that makes the duct liner 10 easier to clean can be used.

In one exemplary embodiment, the facing 14 is suitable for a fibrous insulation product. Facing materials that are suitable for fibrous insulation products include, but are not limited to, a nonwoven mat, web, or a veil. The facing may include a waterless, thin-film adhesive adhered thereto. The facing 14 may include a fibrous web and a waterless, thin-film adhesive adhered to a major surface of the fibrous web. The fibrous web may be forming from fibers such as, but not limited to, glass fibers, mineral wool, rock wool, polymer fibers, synthetic fibers, and/or natural fibers. As used in this application, the term “natural fiber” is meant to indicate plant fibers extracted from any part of a plant, including, but not limited to, the stein, seeds, leaves, roots, or bast. Desirably, the fibrous web is formed of organic fibers such as rayon, polyethylene, polypropylene, nylon, polyester, and mixtures thereof. Continuous fibers and/or multi-component fibers such as bicomponent or tricomponent polymer fibers may also be utilized in forming the facing 14. The bicomponent fibers may be formed in a sheath-core arrangement in which the sheath is formed of first polymer fibers that substantially surround a core formed of second polymer fibers. Although the facing is preferably a non-woven web formed by conventional dry-laid processes, other materials such as point bonded, woven, and other non-woven materials such as needled, spunbonded, or meltblown webs may be used. A binder, flame-retardants, pigments, and/or other conventional additives may also be included in the facing 14. Optionally, the facing 14 may be treated with a fungicide and/or bactericide either during or after manufacturing. Similarly, the waterless, thin-film adhesive may be heat bonded to a facing 14 and subsequently applied to a fibrous insulation product.

The facing 14 may be disposed on the insulation layer 12 in a wide variety of different ways. In one exemplary embodiment, the facing 14 is adhered to the insulation layer 12. Any portion of the facing 14 can be adhered to any portion of the insulation layer. For example, the strips 26 are adhered to the second face surface 22, the facing portions 28 are adhered to the first and second lateral edge surfaces 16, 18 of the insulation layer 12, and/or the facing 14 is adhered to the first face surface 20. In one exemplary embodiment, the strips 26 are adhered to the second face surface 22, the facing portions 28 are not adhered to the first and second lateral edge surfaces 16, 18 of the insulation layer 12, and the facing 14 is adhered to the first face surface 20. Any portion or portions of the facing 14 can be adhered to any portion or portions of the insulation layer.

The facing 14 can be adhered to the insulation layer 12 in a wide variety of different ways. For example, the facing can be adhered to the insulation layer with an adhesive, by ultrasonic welding, or the facing can be fastened to the insulation layer by mechanical fasteners. A wide variety of different adhesives can be used to adhere the facing 14 to the insulation layer 12. For example, the adhesive can be a water base adhesive, a one part adhesive, a two part adhesive, a powder adhesive, a hot melt adhesive, thin film adhesives, a binder, such as a formaldehyde free binder and a spunbond hot melt adhesive web. Spunbond hot melt adhesive webs are available from Spunfab of Cuyahoga Falls, Ohio. The adhesive 32 may be applied in a wide variety of different ways. The adhesive may be applied to the insulation layer 12 and/or the facing 14, for example by spraying, rolling, brushing, etc. When a binder is used, the binder may be a binder that is part of the insulation layer 12 and/or the facing 14 and curing of the binder adheres the insulation layer 12 to the facing 14. In one exemplary embodiment, the adhesive is applied to the strips 26 to adhere the strips to the second face surface 22, adhesive is not applied to the facing portions 28 such that the facing portions 28 are not adhered to the first and second lateral edge surfaces 16, 18 of the insulation layer 12, and adhesive is applied to the central portion 36 of the facing 14 such that the central portion 36 is adhered to the first face surface 20. In one exemplary embodiment, the adhesive is applied to the second face surface 22 of the insulation layer 12 to adhere the strips 26 thereto, adhesive is not applied to the first and second lateral edge surfaces 16, 18 such that the facing portions 28 are not adhered to the first and second lateral edge surfaces 16, 18 of the insulation layer 12, and adhesive is applied to the first face surface 20 such that that the central portion 36 is adhered to the first face surface 20. The duct liner 10 may be easier to roll and/or may be easier to form into the shape of a duct if the lateral edge surfaces 16, 18 are not adhered to the facing portions 28.

In one exemplary embodiment, the adhesive is a waterless, thin-film adhesive, such as a thermoplastic that is heat activated. In exemplary embodiments, the waterless, thin-film adhesive has a thickness less than or equal to about 60 microns, from about 6.0 to about 30.0 microns, or from about 10 microns to about 15 microns. The waterless, thin-film adhesive is applied to the facing material via the application of heat. For instance, the waterless, thin-film adhesive may be positioned on the facing and then adhered to the facing by heating the facing material with a hot plate or other suitable heating device (e.g., an oven). The facing material may similarly be adhered to the insulation layer 12 by heating the facing and the insulation layer to a temperature at or above the melting point of the waterless, thin-film adhesive for a time sufficient to adhere the facing to the insulation layer. Non-limiting examples of suitable adhesives include an ethylene copolymer, polyurethane, ethylene vinyl acetate (EVA), amorphous polyolefin, polyethylene, low density polyethylene (LDPE), cellophane, polyethylene terephthalate (PETP), polyvinyl chloride (PVC) nylons, polypropylene, polystyrene, polyamides, and cellulose acetate.

A wide variety of mechanical fastening arrangements may be used to fasten the facing 14 to the insulation layer 14. The mechanical fastening arrangements may be used in combination with or in lieu of adhesives, ultrasonic welding, and/or other types of bonding. Examples of mechanical fastening arrangements that can be used to connect the facing 14 to the insulation layer 14 include, but are not limited to, pinning, needling, sewing, and gripping or friction type fasteners. Any type of fastener that allows the facing 14 to be attached to the insulation layer 12 can be used.

FIGS. 4A-4C, 5A-5C, 6A-6C, 7A-7D, and 8A-8D illustrate exemplary embodiments of methods of making a duct liners. In each of these methods, an insulation layer 12 and a facing 14 are provided. The facing 14 is wrapped around the insulation layer 12, such that the facing is disposed on the first face layer 20, on the first and second edge surfaces 16,18, and two spaced apart strips 26 of the facing are disposed on and cover a portion of the second face surface 22 adjacent to the first and second edge surfaces 16, 18. In the illustrated embodiment, the portion 30 of the second face surface 22 between the strips 26 is uncovered by the facing 14.

In the exemplary embodiment illustrated by FIGS. 4A-4C, a preformed insulation layer 12 is placed on top of the facing 14 (see FIG. 4A). The facing may optionally be pre-folded, pre-formed, or pleated. For example, the facing may have crease lines 38 that are positioned on the facing to correspond to the width W of the insulation layer 12 and may have crease lines 40 that correspond to the thickness T of the insulation layer. The facing 14 may be wound on a roll after the pre-folding or pleating. Then, the facing may be unwound from the roll when the duct liner 10 is being fabricated. An adhesive is provided on the insulation layer 12 and/or the facing (see FIG. 4A). The adhesive may be sprayed on the adhesive may be pre-applied and/or be part of the insulation layer 12 and/or the facing. Referring to FIG. 4B, the facing 14 is folded to cover the lateral side edges. Referring to FIG. 4C, the facing 14 is folded onto the second face surface 22 to form the spaced apart strips 26. The adhesive 32 is cured to form the finished duct liner 10.

In the exemplary embodiment illustrated by FIGS. 5A-5C, a facing 14 is placed on top of a preformed insulation layer 12 (see FIG. 5A). The facing may optionally be pre-folded, pre-formed, or pleated. For example, the facing may have crease lines 38 that are positioned on the facing to correspond to the width W of the insulation layer 12 and may have crease lines 40 that correspond to the thickness T of the insulation layer. This prefolding of the facing defines a central portion 36 that covers the first face surface 20, the pair of edge covering portions 28 on opposite sides of the central portion, and the pair of strips 26 extend from the pair of edge covering portions. The facing 14 may be wound on a roll after the pre-folding or pleating. Then, the facing may be unwound from the roll when the duct liner 10 is being fabricated. An adhesive is provided on the insulation layer 12 and/or the facing 14. The adhesive 32 may be sprayed on or the adhesive may be pre-applied and/or be part of the insulation layer 12 and/or the facing 14. Referring to FIG. 5B, the facing 14 is folded to cover the lateral side edges 16, 18. Referring to FIG. 5C, the facing 14 is folded onto the second face surface 22 to form the spaced apart strips 26. The adhesive is cured to form the finished duct liner 10.

In the exemplary embodiments illustrated by FIGS. 6A-6C, the insulation layer 12 is formed directly on top of the facing 14. This direct forming may be done in a variety of different ways. For example, US Published Patent Application No. 2010/0000170 to Parks, which is incorporated herein by reference, discloses methods of applying a pack of glass fibers to a facing and vice versa. However, any type of insulation layer 12 can be formed directly on top of the facing 14. In another embodiment, the facing 14 is provided on top of an uncured pack of glass fibers (see for example FIG. 4 of US 2010/0000170 and FIGS. 5A-5C of the present application).

Referring to FIG. 6A and FIG. 28, which corresponds to FIG. 2 of US Published Patent Application No. 2010/0000170, fiberizing spinners 115 (FIG. 28) form glass fibers 130 that are blown generally downwardly to position the glass fibers 130 on the facing within a forming chamber 125. In an exemplary embodiment, the glass fibers, while still hot, are sprayed with an aqueous binder composition. Guides 44 (FIG. 6A) may be included to define the sides of the pack 140. The guides 44 may be included at any point along the line illustrated by FIG. 28 or a station may be added where the width of the insulating layer 12 is defined. The glass fibers 130 having the uncured resinous binder adhered thereto may be gathered and formed into an uncured pack 140 by the guides 44 on the facer 12 on an endless forming conveyor 145. The facing 14 may have a pre-applied waterless, adhesive disposed on the side that the glass fibers 130 are being applied to. This adhesive may be applied to the entire surface of the facing, or only the portion that the glass fibers are dropped onto. The facing may be supplied to the conveyor 145 by a roll 190.

The insulation pack may be compressed to allow the facing 14 to be wrapped around the lateral edges 16, 18 of the compressed uncured pack 140. For example, the uncured pack 140 may be compressed by upper and lower conveyors 165, 170 to form the faced fibrous insulation product 10 having a predetermined thickness (see FIG. 28). As with all of the embodiments disclosed herein, the facing 14 illustrated by FIGS. 6A-6C may optionally be pre-folded, pre-formed, or pleated. An adhesive is provided on the insulation layer 12 and/or the facing 14 and/or the binder of the insulation layer may be used to adhere the insulation layer 12 to the facing 14. The pack 140 and the facing 14 are heated, such as by conveying the pack 40 through a curing oven 160 where heated air is blown through the insulation pack 140 and facing to evaporate any remaining water in the binder, cure the binder and the adhesive, rigidly bond the fibers together in the insulation pack 140, and adhere the facing 14 to the insulation pack 140. Referring to FIG. 6C, the facing 14 is folded to cover the lateral side edges and is folded onto the second face surface 22 to form the spaced apart strips 26. For example, the facing 14 may be folded onto the insulation pack 140 as shown in FIG. 6C near an exit 161 of the curing oven 160 of FIG. 28. However, the line may be configured in a wide variety of different ways to fold the facing 14 onto the insulation pack 140.

The duct liner 10 exits the curing oven 160 and may be rolled by roll-up device 182 for storage and/or shipment. The wrapped fibrous insulation product 10 may subsequently be unrolled and cut or die pressed to form fibrous insulation parts (e.g., duct liners and duct boards). Alternatively, the faced fibrous insulation product 10 may be cut to a predetermined length by a cutting device such as a blade or knife to form panels 184 of the faced fibrous insulation. If desired, channels or grooves, such as v-shaped grooves, may be formed in the inner surface of the duct liner 10 for folding or bending the duct liner to fit in a duct.

FIGS. 7A-7D illustrate an exemplary embodiment where an insulation layer 12, such as an uncured pack 140 of glass fibers 130, is provided on top of the facing 14. For example, the uncured pack 140 may be formed directly on the facing as in the embodiment of FIGS. 6A-6C or the uncured pack 140 may be formed at a first location and then placed or conveyed onto the facing 14. Referring to FIG. 7B, once the material that forms the insulation layer is in contact with the facing 14, the insulation layer 12 is cut to define the first and second edge surfaces 16, 18. This cutting may be done in a wide variety of different ways. In the example illustrated by FIG. 7B, a cutting tool 50 is provided close to, but a predetermined distance away from, the facing 14 to cut the insulation layer 12 and define the first and second edge surfaces 16, 18 without cutting the facing 14.

As with all of the embodiments disclosed herein, the facing 14 illustrated by FIGS. 7A-7D may optionally be pre-folded, pre-formed, or pleated. An adhesive is provided on the insulation layer 12 and/or the facing 14 and/or the binder of the insulation layer may be used to adhere the insulation layer 12 to the facing 14. Referring to FIG. 7D, the facing 14 is folded to cover the lateral side edges and is folded onto the second face surface 22 to form the spaced apart strips 26. The adhesive and/or the binder of the insulation layer 12 is cured to form the finished duct liner 10.

FIGS. 8A-8D illustrate another exemplary embodiment where an insulation layer 12, such as an uncured pack 140 of glass fibers 130, is provided on top of the facing 14. For example, the uncured pack 140 may be formed directly on the facing as in the embodiment of FIGS. 6A-6C or the uncured pack 140 may be formed at a first location and then placed or conveyed onto the facing 14. Referring to FIG. 8B, once the material that forms the insulation layer is in contact with the facing 14, the insulation layer 12 is compressed to define said first and second edge surfaces 16, 18 and set the height of the insulation layer 12. This compressing may be done in a wide variety of different ways. In the example illustrated by FIG. 8B, the uncured pack 140 is pressed laterally inward as indicated by arrows 52 and down as indicated by arrows 54.

As with all of the embodiments disclosed herein, the facing 14 illustrated by FIGS. 8A-8D may optionally be pre-folded, pre-formed, or pleated. An adhesive is provided on the insulation layer 12 and/or the facing 14 and/or the binder of the insulation layer may be used to adhere the insulation layer 12 to the facing 14. Referring to FIG. 8D, the facing 14 is folded to cover the lateral side edges and is folded onto the second face surface 22 to form the spaced apart strips 26. The adhesive and/or the binder of the insulation layer 12 is cured to form the finished duct liner 10.

Referring to FIGS. 9-27, the duct liner 10 may be secured to an interior surface of a duct housing 900 to form an insulated duct assembly 902. The illustrated duct housing 900 duct housing having an interior surface 904 and an exterior surface 906. In the illustrated exemplary embodiments, the duct liner 10 is oriented such that the strips 26 of the facing 14 face the interior surface 904 of the housing. In an exemplary embodiment, the strips 26 of the facing 14 are secured to the duct housing 900.

In the exemplary embodiments illustrated by FIGS. 9-23, the duct liners 10 are oriented such that the strips 26 are parallel to the longitudinal direction of the duct assembly. As such, seals between abutting duct liner ends are not needed, since the ends are completely covered by the facing 14. In the exemplary embodiments illustrated by FIGS. 24-27, the duct liners 10 are oriented such that the strips 26 are perpendicular to the longitudinal direction of the duct assembly 902. As such, leading and trailing edge surfaces 16, 18 are covered by the facing 14 and are protected from airflow through the duct.

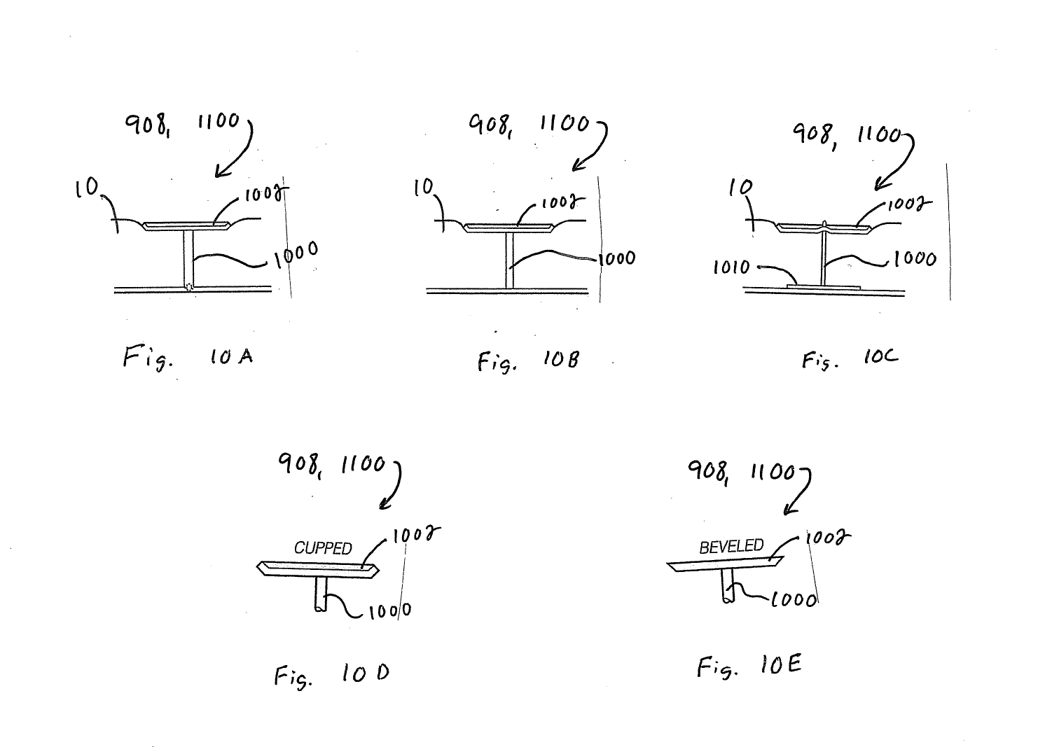

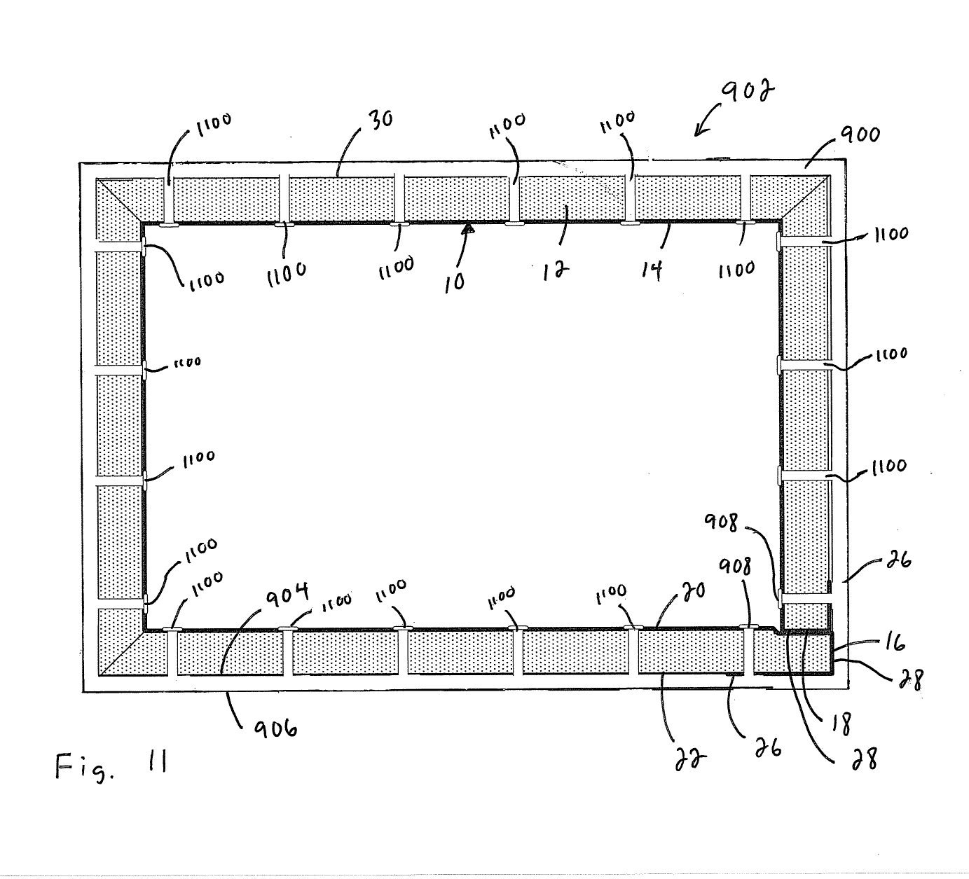

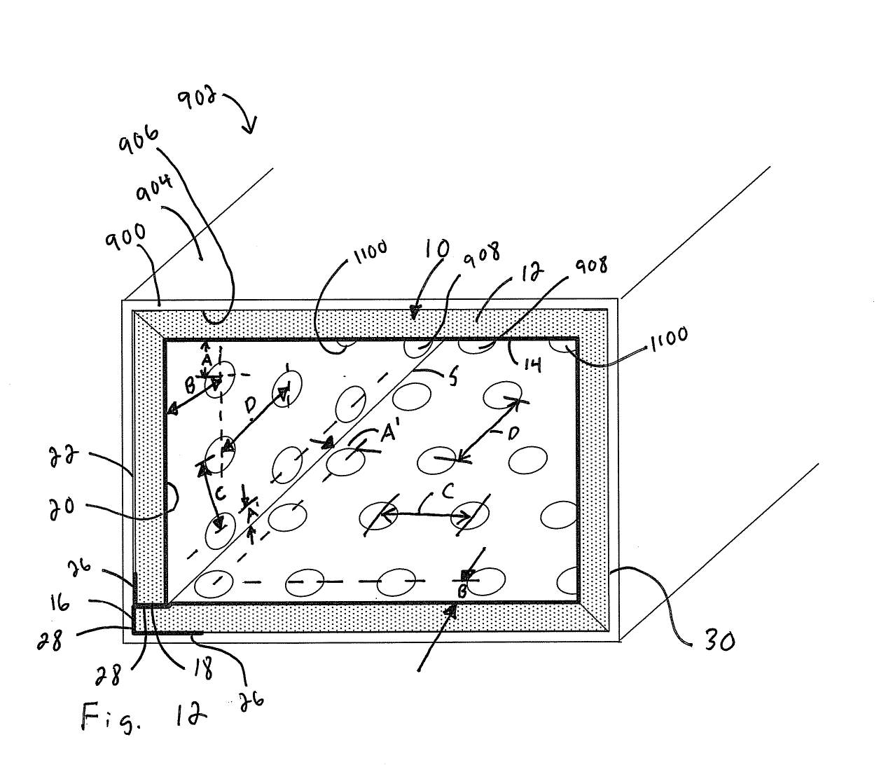

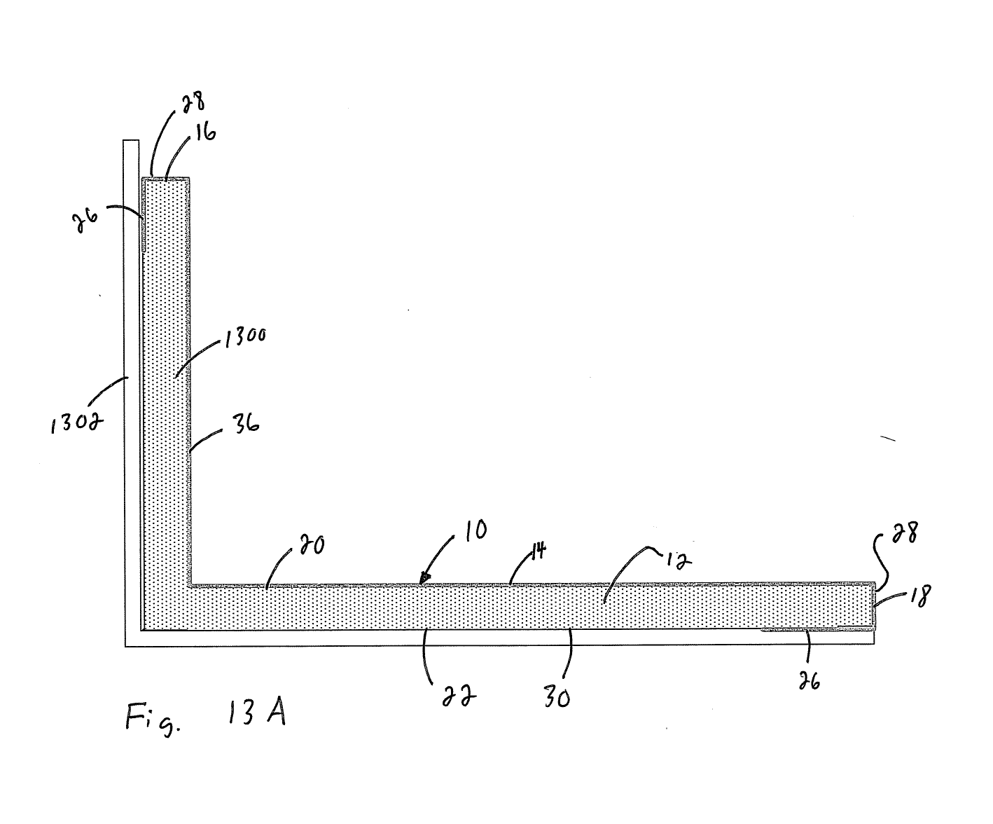

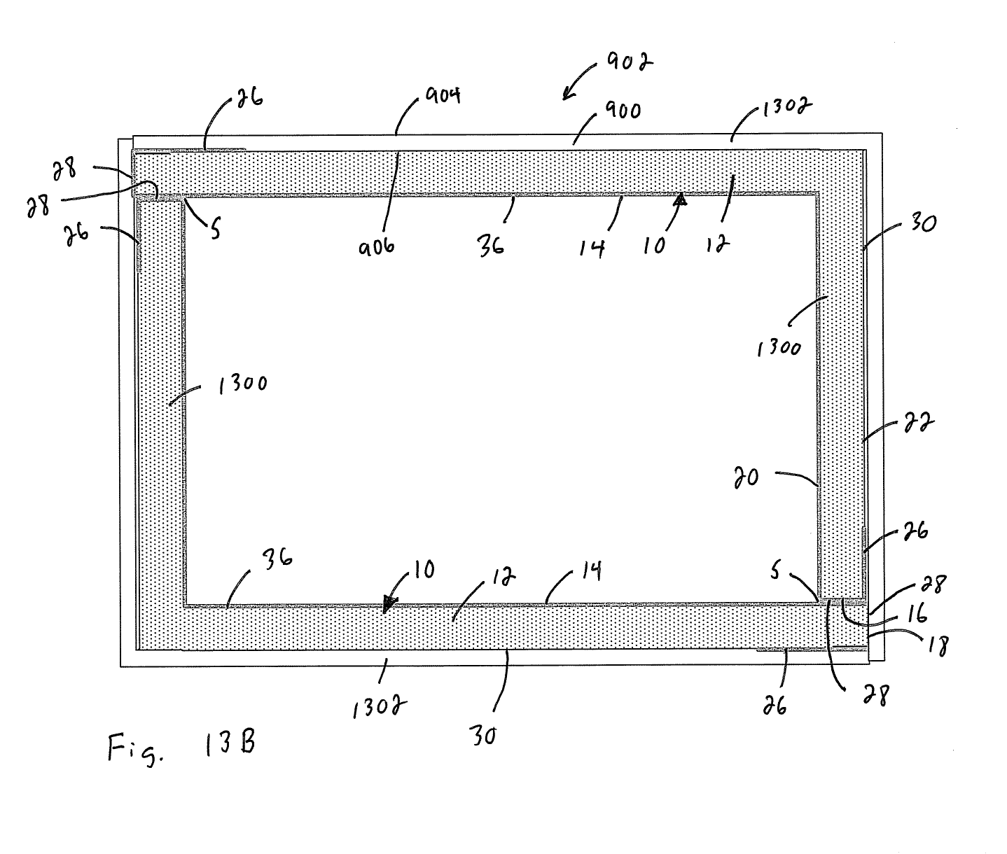

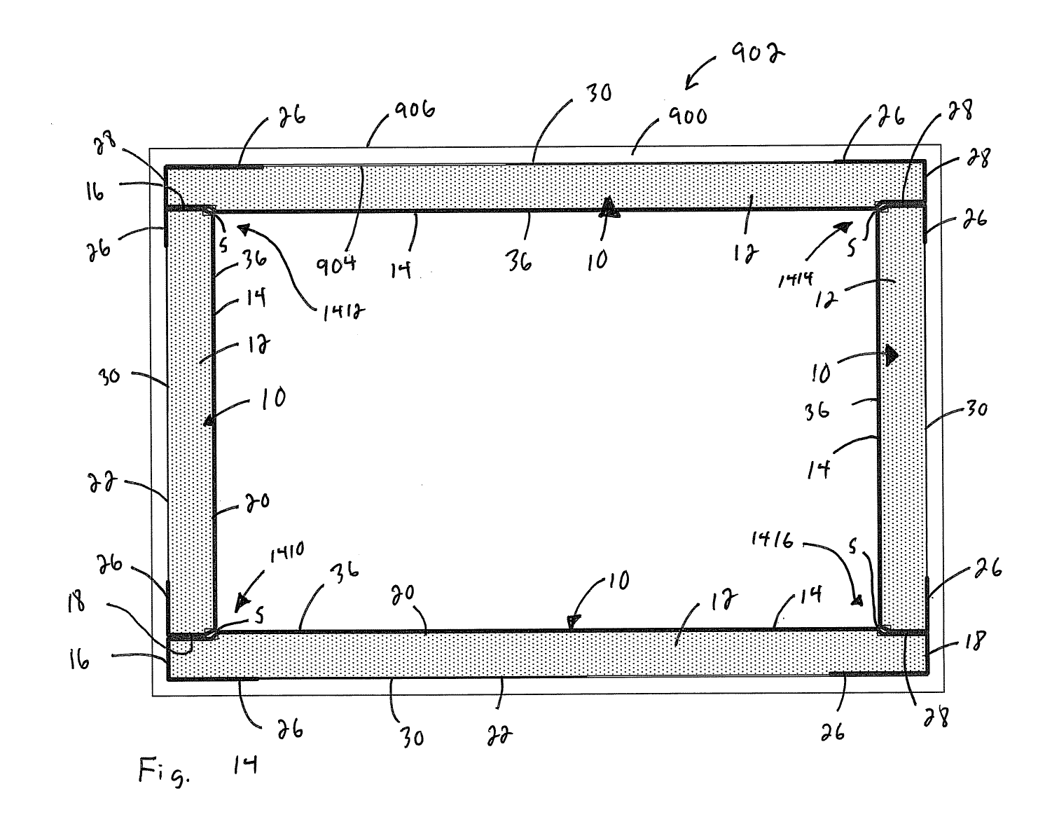

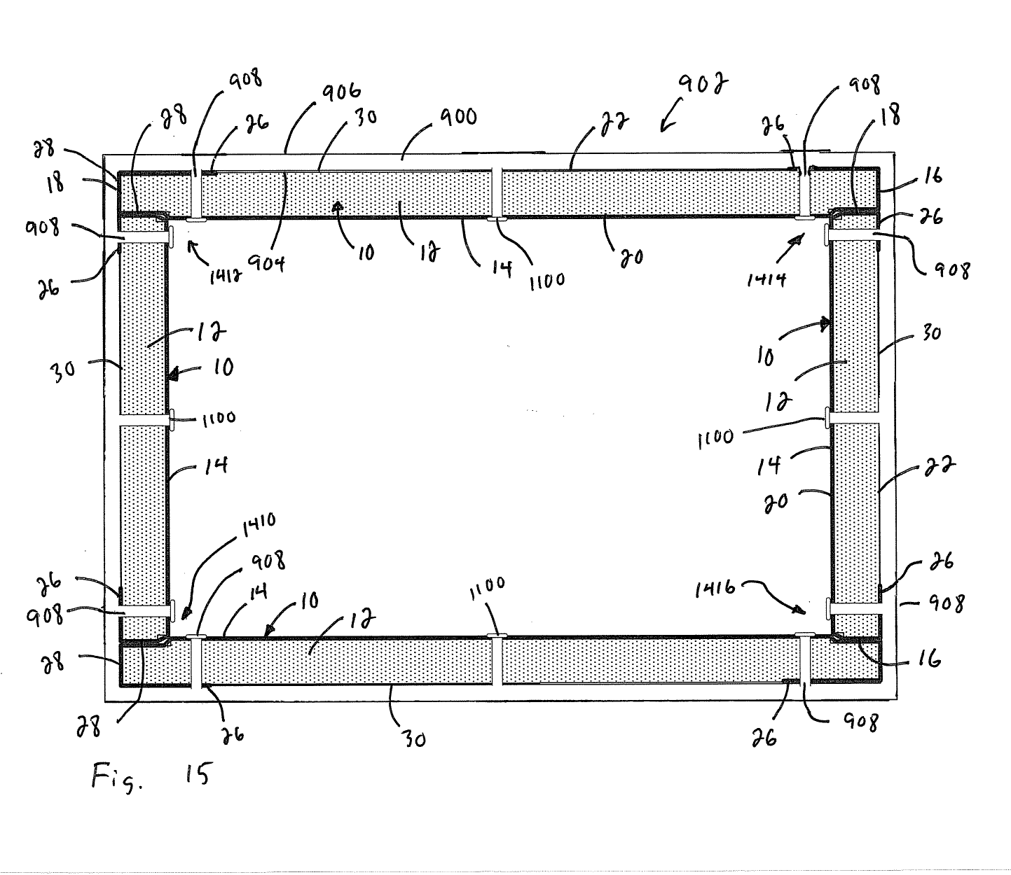

The strips 26 of the facing may be secured to the duct housing in a wide variety of different ways. For example, the strips 26 of the facing 14 may be secured to the duct housing 900 with a fastener 908 (See FIG. 10) and/or with an adhesive. Any manner of securing the strips 26 of the facing 14 to the housing 900 can be used. In one exemplary embodiment, the uncovered portion 30 of the second face surface 22 of the duct liner 10 is optionally secured to the duct housing 900. The uncovered portion 30 may be secured to the duct housing in a wide variety of different ways. For example, the uncovered portion 30 may be secured to the duct housing 900 with fasteners 1100 (See FIG. 11) and/or with an adhesive. The fasteners 908 may be substantially the same as the fasteners 1100 or the fasteners 908 may be different than the fasteners 1100. Any manner of securing the uncovered portion 30 to the housing 900 can be used.

The duct assembly 902 may have a wide variety of different configurations. FIGS. 9-27 illustrate a few of the possible configurations. In the examples illustrated by FIGS. 9-27, the housing 900 has a rectangular shape in cross-section. However, the housing may have any shape. In the example illustrated by FIG. 9, a single piece of duct liner 10 is used to insulate the entire interior surface 904 of the duct housing 900. The example illustrated by FIG. 9 and the other examples disclosed herein where the strips 24 are parallel to the longitudinal direction of the duct assembly 902, the orientation of the duct liner may be changed such that the strips 24 are perpendicular to the longitudinal direction of the duct assembly. The duct liner 10 is folded at the corners 910, 912, 914. At the corner 916, the ends of the duct liner 10 are lapped and compressed. The portion 28 of the facing 14 on the lateral edge 18 engages a portion of the facing 14 on the face surface 20. As such, no portion of the insulation layer 12 is exposed to the airflow through the duct assembly. The strips 26 and/or the uncovered portion 30 may be secured to the duct housing 900 in an exemplary embodiment.

FIG. 10 illustrates and exemplary embodiment that is similar to the exemplary embodiment illustrated by FIG. 9, except the duct liner 10 is secured to the duct housing 900 by fasteners 908. The fasteners 908 and other fasteners mentioned in this application may take a wide variety of different forms. For example, referring to FIGS. 10A, 10B, 10 C, 10D, and 10E, the fasteners 908 may comprise pins 1000 that are attached to the duct housing with heads 1002 connected to the end of the pins. The heads 1002 hold the duct liner 10 securely against the duct housing 900. In the example illustrated by FIG. 10A, the head 1002 is attached to the pin 1000. The pin 1000 is impact driven into the duct housing to form a positive mechanical attachment to the duct housing. In the example illustrated by FIG. 10B, the head 1002 is attached to the pin 1000. The pin 1000 is impact welded to the duct housing, such as by resistance or capacitance welding. In the example illustrated by FIG. 10C, the head 1002 is attached to a large base 1010. The large base 1010 allows the pin 1000 to be connected to the housing by an adhesive or by welding. In the example illustrated by FIG. 10C, the head 1002 is pressed onto the pin 1000 to secure the duct liner 10 to the duct housing 900. The head may take a wide variety of different forms. In one exemplary embodiment, the head 1002 is configured to prevent the head from damaging the facing 14. For example, in the example illustrated by FIG. 10D, the head is cupped and in the example illustrated by FIG. 10E, the head is beveled. It should be readily apparent that a wide variety of other types of fasteners could also be used to secure the duct liner to the duct housing 900.

The fasteners may be configured to connect the duct liner 10 to the duct housing 900 in a wide variety of different ways. In the example illustrated by FIG. 10, the fastener 908 is secured to the duct housing 900. The fasteners 908 each extend through one of the strips 26 of the facing 14, through the insulation layer 12, and through the central portion 36 of the facing 14 that is disposed on the first face 20 of the insulation layer. This arrangement securely attaches the two ends of the duct liner 10 to the duct housing 900. The strips 26 provide an extra layer of reinforcement to the two ends of the duct liner 10. The strips 26 may also be adhered to the interior surface 904 of the duct housing 900 by an adhesive.

FIGS. 11 and 12 illustrate an exemplary embodiment that is similar to the exemplary embodiment illustrated by FIG. 10, except the duct liner 10 is secured to the duct housing 900 by fasteners 908 that extend through the strips 26 of the facing and by fasteners 1100 that do not extend through the strips 26. In the example illustrated by FIGS. 11 and 12, the fasteners 908, 1100 are secured to the duct housing 900. The fasteners 908 each extend through one of the strips 26 of the facing 14, through the insulation layer 12, and through the central portion 36 of the facing 14 that is disposed on the first face 20 of the insulation layer. The fasteners 1100 each extend through the insulation layer 12, and through the central portion 36 of the facing 14 that is disposed on the first face 20 of the insulation layer, but do not extend through one of the strips 26 of the facing 14. This arrangement securely attaches both the two ends 918, 920 of the duct liner 10 and the uncovered portion 30 of the duct liner 10 to the duct housing 900. The strips 26 provide an extra layer of reinforcement to the two ends 918, 920. The strips 26 and/or the uncovered portion 30 may also be adhered to the interior surface 904 of the duct housing 900 by an adhesive.

Referring to FIG. 12, the spacing between the fasteners 908, 1100 may be selected based on the velocity of the air that will flow through the duct. In one exemplary embodiment, the spacing between the fasteners 908, 1100 is as follows:

| | | Dimension | Dimension |
|---|---|---|---|
| | | for | for |
| | | 0-2500 feet | 2501-6000 feet |
| Reference | Description | per minute | per minute |
| A | From corners of duct to | 1-4″ | 1-4″ |
| | fasteners 1100 | | |
| A′ | From corners of duct to | 1-2″ | 1-2″ |
| | fasteners 908 | | |
| B | From transverse end of duct | 1-3″ | 1-3″ |
| | liner | | |
| C | Across width of duct, on | 10-14″ | 4-6″ |
| | centers (min. 1 per side) | | |
| D | Along length of duct, on | 17-18″ | 14-16″ |
| | centers (min. 1 per side) | | |

The duct housing 900 may be formed in a wide variety of different ways. The duct housing 900 may be made from sheetmetal, plastic, or other materials. In one exemplary embodiment, the duct housing is made from bent sheetmetal. Referring to FIGS. 13A and 13B, pieces 1300 of duct liner 10 are secured to L-shaped sheetmetal panels 1302. The example illustrated by FIGS. 13A and 13B and the other examples disclosed herein where the strips 24 are parallel to the longitudinal direction of the duct assembly 902, the orientation of the duct liner pieces may be changed such that the strips 24 are perpendicular to the longitudinal direction of the duct assembly. The pieces 1300 may be applied to the sheetmetal panels 1302, before or after the panels are bent into the L-shape. Referring to FIG. 13B, two L-shaped sheetmetal panels with attached duct liner 10 are assembled together to form a duct assembly 902. In other embodiments, the duct housing 900 is formed from more or less sheetmetal panels. For example, the duct housing 900 may be formed from a single piece of sheetmetal.

FIG. 14 illustrates another duct assembly configuration. In the example illustrated by FIG. 14, four pieces of duct liner 10 are used to insulate the interior surface 904 of the duct housing 900. The duct liner 10 is lapped an compressed at the corners 1410, 1412, 1414, 1416. Portions 28 of the facing 14 on the lateral edges 16 engage the facing 14 on the first face surface. As such, no portion of the insulation layer 12 is exposed to the airflow through the duct assembly. The strips 26 and/or the uncovered portion 30 may be secured to the duct housing 900 in an exemplary embodiment. The example illustrated by FIG. 14 and the other examples disclosed herein where the strips 24 are parallel to the longitudinal direction of the duct assembly 902, the orientation of the duct liner pieces may be changed such that the strips 24 are perpendicular to the longitudinal direction of the duct assembly.

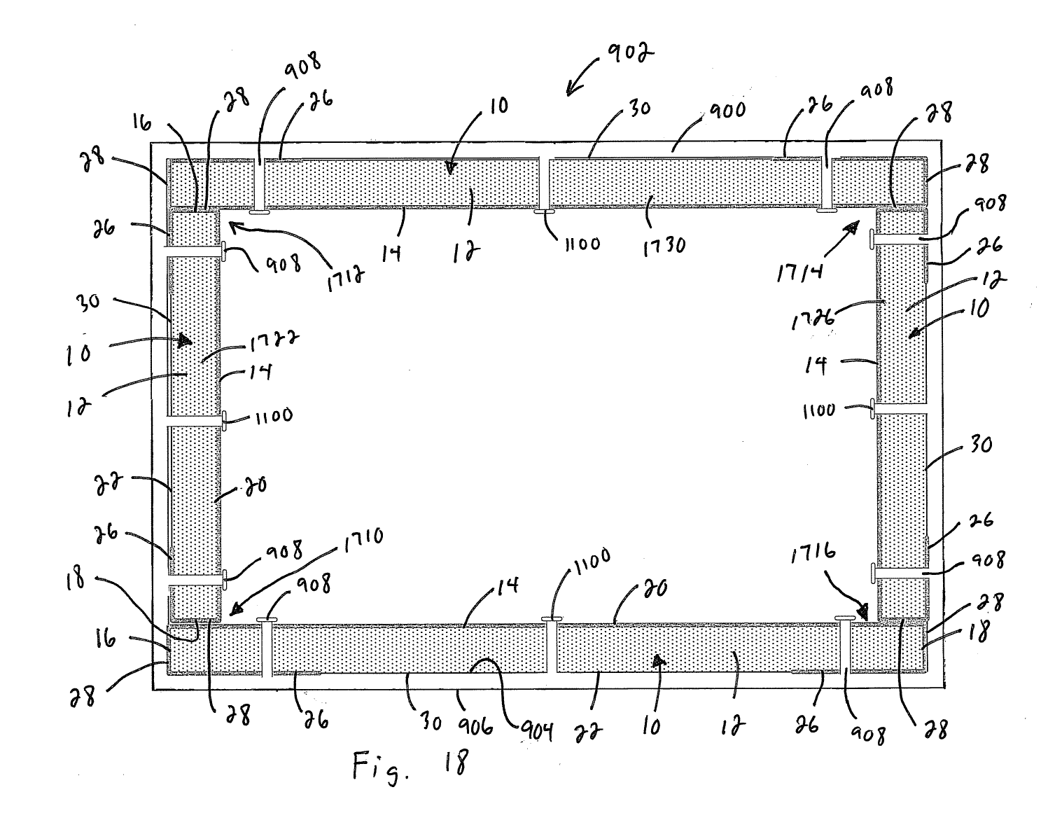

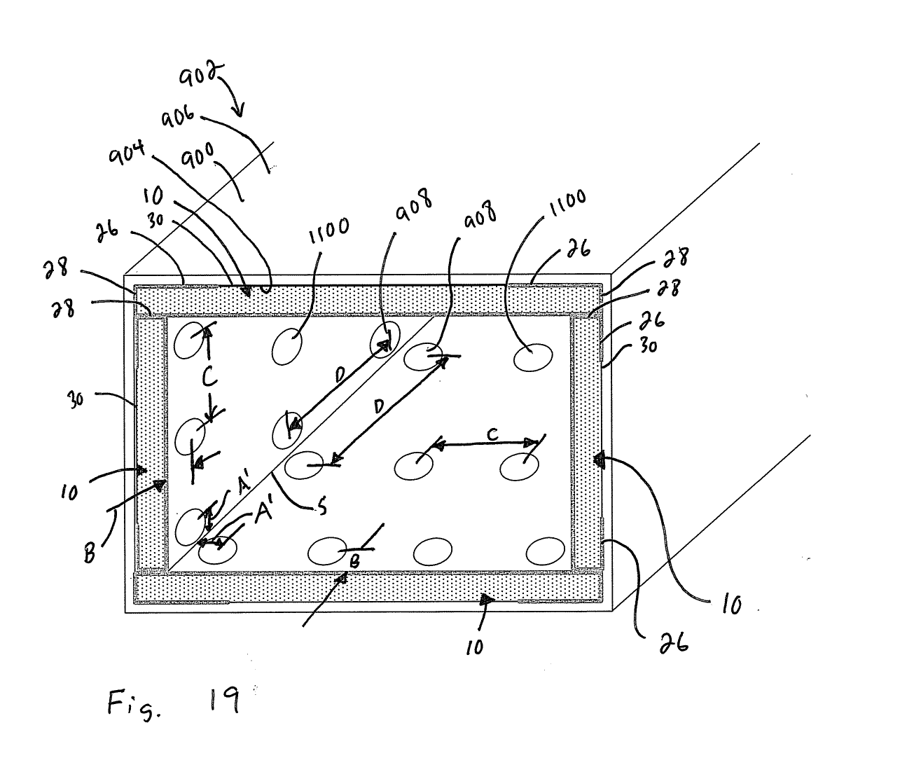

FIGS. 15 and 16 illustrate an exemplary embodiment that is similar to the exemplary embodiment illustrated by FIG. 14, except the duct liner 10 is secured to the duct housing 900 by fasteners 908, 1100. In the example illustrated by FIGS. 15 and 16, the fasteners 908, 1100 are secured to the duct housing 900. The fasteners 908 each extend through one of the strips 26 of the facing 14, through the insulation layer 12, and through the central portion 36 of the facing 14 that is disposed on the first face 20 of the insulation layer. The fasteners 1100 each extend through the insulation layer 12, and through the central portion 36 of the facing 14 that is disposed on the first face 20 of the insulation layer, but do not extend through one of the strips 26 of the facing 14. This arrangement securely attaches both the two ends of the duct liner 10 and the uncovered portion 30 of the duct liner 10 to the duct housing 900. The strips 26 and/or the uncovered portion 30 may also be adhered to the interior surface 904 of the duct housing 900 by an adhesive.

Referring to FIG. 16, the spacing between the fasteners 908, 1100 may be selected based on the velocity of the air that will flow through the duct. In one exemplary embodiment, the spacing between the fasteners 908, 1100 is as follows:

| | | Dimension | Dimension |
|---|---|---|---|
| | | for | for |
| | | 0-2500 feet | 2501-6000 feet |
| Reference | Description | per minute | per minute |
| A′ | From corners of duct to | 1-2″ | 1-2″ |
| | fasteners 908 | | |
| B | From transverse end of duct | 1-3″ | 1-3″ |
| | liner | | |
| C | Across width of duct, on | 10-14″ | 4-6″ |
| | centers (min. 1 per side) | | |
| D | Along length of duct, on | 17-18″ | 14-16″ |
| | centers (min. 1 per side) | | |

FIG. 17 illustrates another duct assembly configuration. The duct assembly illustrated by FIG. 17 is substantially the same as the duct assembly illustrated by FIG. 14, except the corners are not compressed. In the example illustrated by FIG. 17, four pieces of duct liner 10 are used to insulate the interior surface 904 of the duct housing 900. The duct liner 10 is lapped at the corners 1710, 1712, 1714, 1716. Side pieces 1722, 1726 support a top piece 1730. Portion 28 of the facing 14 on the lateral edges 16 engage the facing 14 on the end of the face surface 22. As such, no portion of the insulation layer 12 is exposed to the airflow through the duct assembly. The example illustrated by FIG. 17 and the other examples disclosed herein where the strips 24 are parallel to the longitudinal direction of the duct assembly 902, the orientation of the duct liner pieces may be changed such that the strips 24 are perpendicular to the longitudinal direction of the duct assembly.

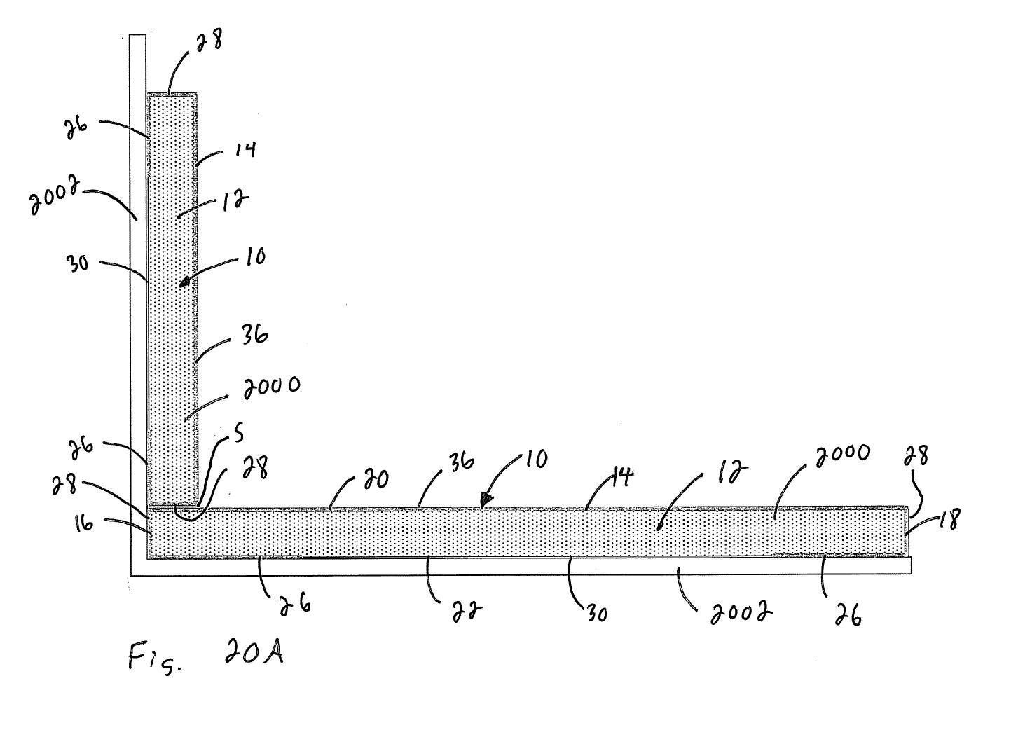

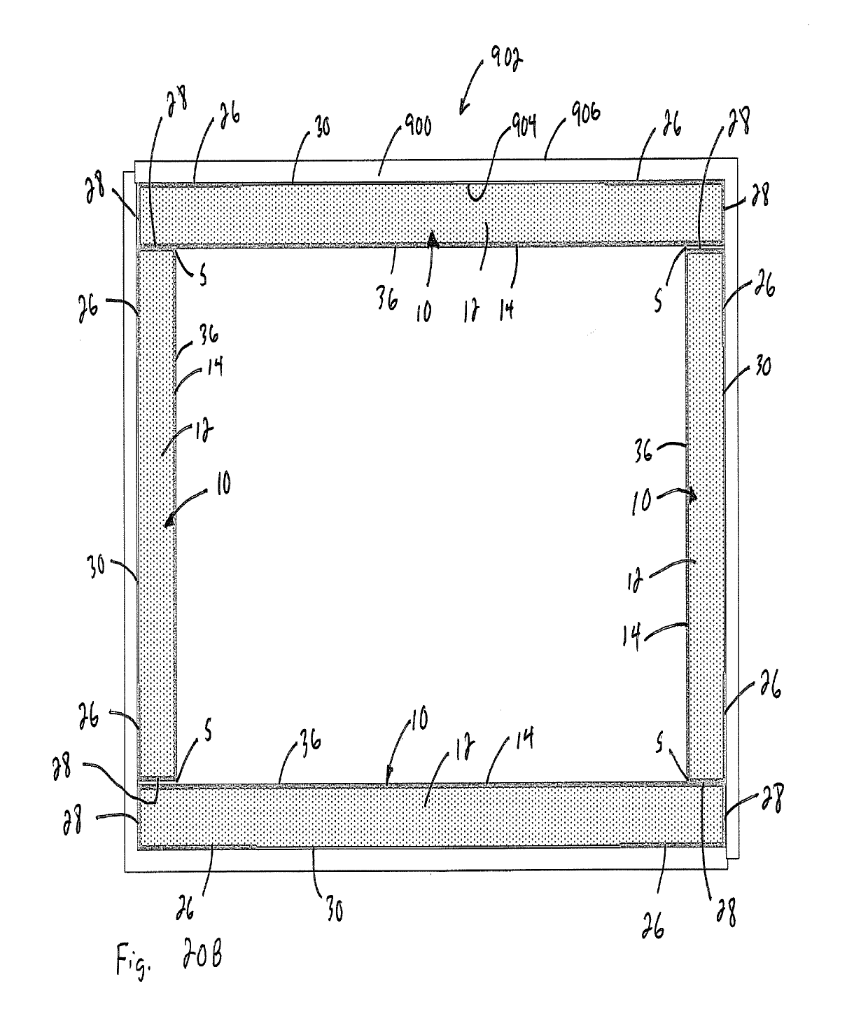

FIGS. 18 and 19 illustrate an exemplary embodiment that is similar to the exemplary embodiment illustrated by FIG. 17, except the duct liner 10 is secured to the duct housing 900 by fasteners 908, 1100. In the example illustrated by FIGS. 18 and 19, the fasteners 908, 1100 are secured to the duct housing 900. The fasteners 908 each extend through one of the strips 26 of the facing 14, through the insulation layer 12, and through the central portion 36 of the facing 14 that is disposed on the first face 20 of the insulation layer. The fasteners 1100 each extend through the insulation layer 12, and through the central portion 36 of the facing 14 that is disposed on the first face 20 of the insulation layer, but do not extend through one of the strips 26 of the facing 14. This arrangement securely attaches both the two ends of each duct liner 10 and the uncovered portion 30 of each duct liner 10 to the duct housing 900. The strips 26 and/or the uncovered portion 30 may also be adhered to the interior surface 904 of the duct housing 900 by an adhesive.

Referring to FIG. 19, the spacing between the fasteners 908, 1100 may be selected based on the velocity of the air that will flow through the duct. In one exemplary embodiment, the spacing between the fasteners 908, 1100 is as follows:

| | | Dimension | Dimension |
|---|---|---|---|
| | | for | for |
| | | 0-2500 feet | 2501-6000 feet |
| Reference | Description | per minute | per minute |
| A′ | From corners of duct to | 1-2″ | 1-2″ |
| | fasteners 908 | | |
| B | From transverse end of duct | 1-3″ | 1-3″ |
| | liner | | |
| C | Across width of duct, on | 10-14″ | 4-6″ |
| | centers (min. 1 per side) | | |
| D | Along length of duct, on | 17-18″ | 14-16″ |
| | centers (min. 1 per side) | | |

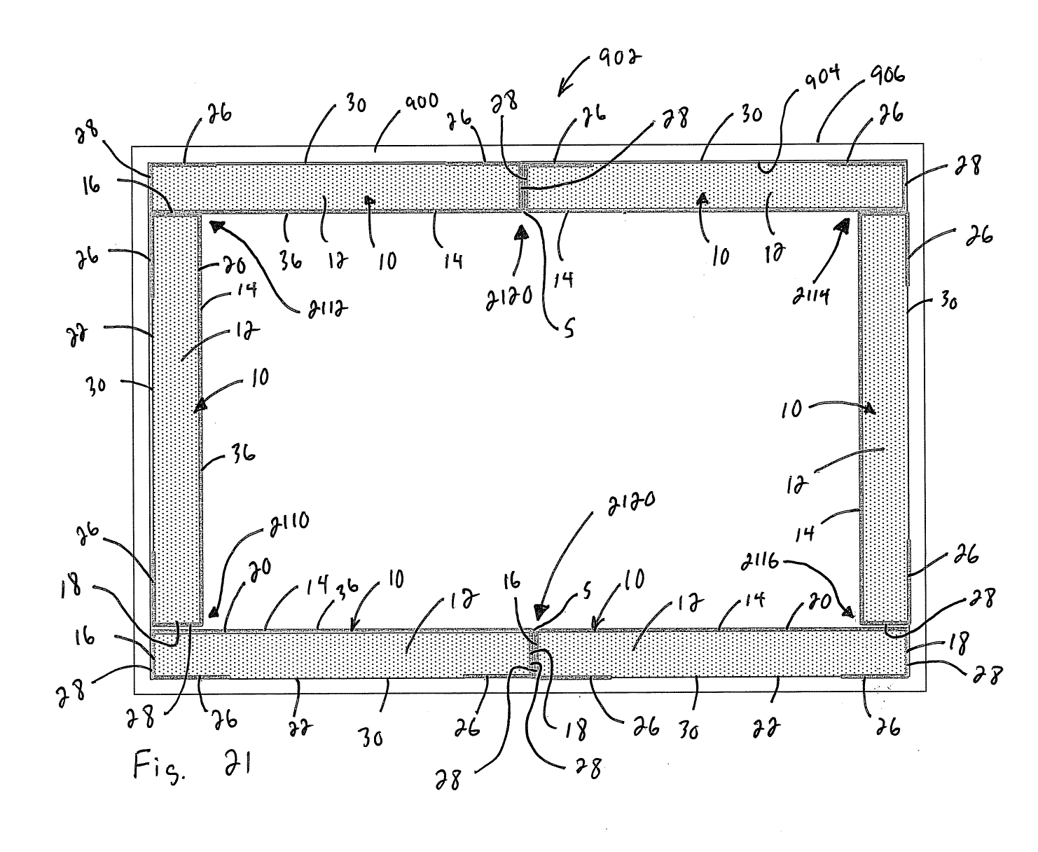

Referring to FIGS. 20A and 20B, pieces 2000 of duct liner 10 are secured to L-shaped sheetmetal panels 2002. The pieces 2000 may be applied to the sheetmetal panels 2002, before or after the panels are bent into the L-shape. Referring to FIG. 20B, two L-shaped sheetmetal panels each with two pieces of attached duct liner 10 are assembled together to form a duct assembly 902. In other embodiments, the duct housing 900 is formed from more or less sheetmetal panels. For example, the duct housing 900 may be formed from a single piece of sheetmetal. The example illustrated by FIGS. 20A and 20B and the other examples disclosed herein where the strips 24 are parallel to the longitudinal direction of the duct assembly 902, the orientation of the duct liner pieces may be changed such that the strips 24 are perpendicular to the longitudinal direction of the duct assembly.

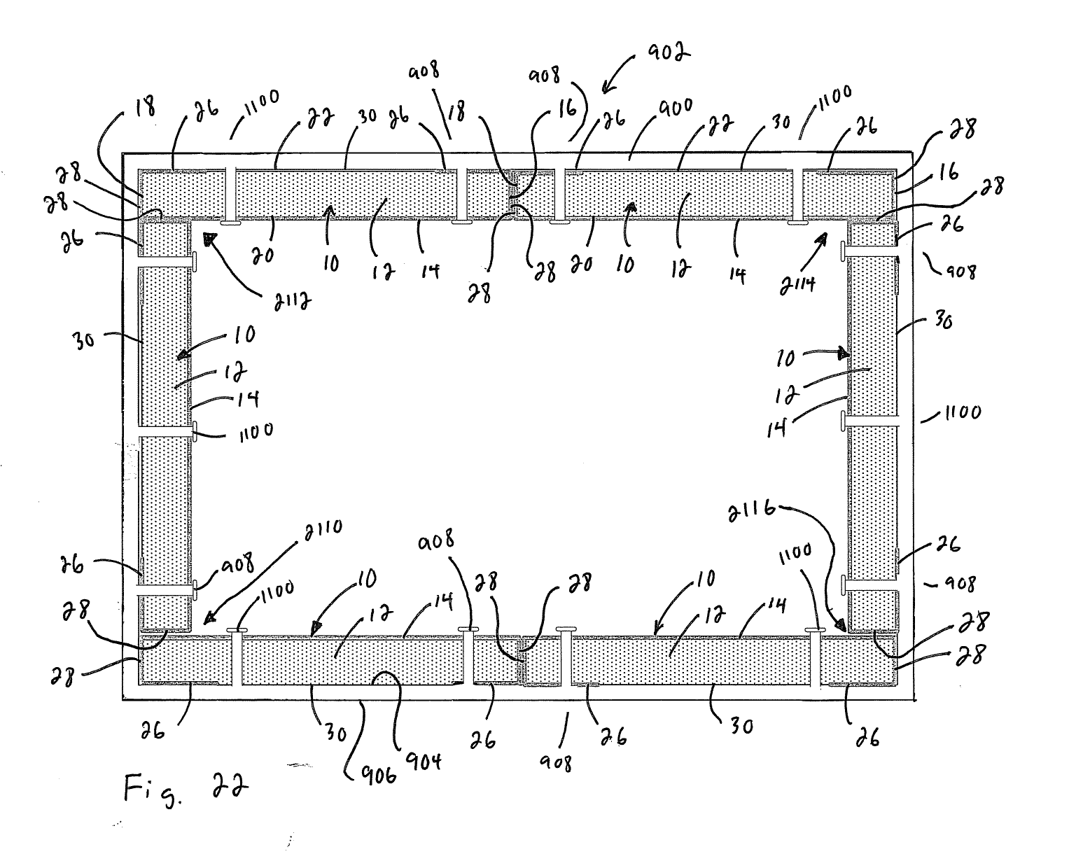

FIG. 21 illustrates another duct assembly configuration. In the example illustrated by FIG. 21, six pieces of duct liner 10 are used to insulate the interior surface 904 of the duct housing 900. The duct liners 10 are lapped at the corners 2110, 2112, 2114, 2116. Portions 28 of the facing 14 on the lateral edges 16 engage the facing 14 on the second surface 22 at the end of the duct liner. Butt joints 2120 are formed between the top and bottom duct liners 10. Since the facing 14 extends around the lateral edges 16, the facing 14 of one duct liner 10 engages the facing of the adjacent duct liner at the butt joints. In the configuration illustrated by FIG. 21, no portion of the insulation layer 12 is exposed to the airflow through the duct assembly. The strips 26 and/or the uncovered portion 30 may be secured to the duct housing 900 in an exemplary embodiment. The example illustrated by FIG. 21 and the other examples disclosed herein where the strips 24 are parallel to the longitudinal direction of the duct assembly 902, the orientation of the duct liner pieces may be changed such that the strips 24 are perpendicular to the longitudinal direction of the duct assembly.

FIG. 22 illustrates an exemplary embodiment that is similar to the exemplary embodiment illustrated by FIG. 21, except the duct liner 10 is secured to the duct housing 900 by fasteners 908, 1100. In the example illustrated by FIG. 22, the fasteners 908, 1100 are secured to the duct housing 900. The fasteners 908 each extend through one of the strips 26 of the facing 14, through the insulation layer 12, and through the central portion 36 of the facing 14 that is disposed on the first face 20 of the insulation layer. The fasteners 1100 each extend through the insulation layer 12, and through the central portion 36 of the facing 14 that is disposed on the first face 20 of the insulation layer, but do not extend through one of the strips 26 of the facing 14. This arrangement securely attaches both the two ends 918, 920 of the duct liner 10 and the uncovered portion 30 of the duct liner 10 to the duct housing 900. The strips 26 and/or the uncovered portion 30 may also be adhered to the interior surface 904 of the duct housing 900 by an adhesive. FIG. 22 illustrates an example that shows that a fastener does not have to extend through all of the strips 26.

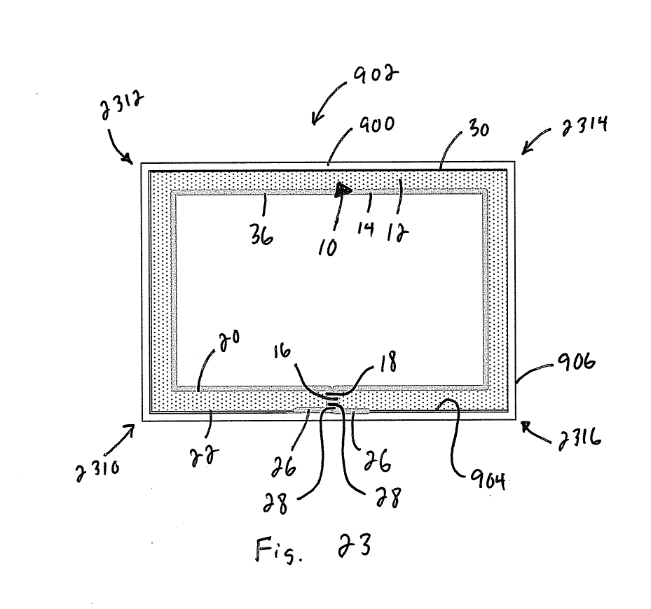

FIG. 23 illustrates another exemplary embodiment of a duct assembly 902 configuration. In the example illustrated by FIG. 23, a single piece of duct liner 10 is used to insulate the entire interior surface 904 of the duct housing 900. The duct liner 10 is folded at the corners 2310, 2312, 2314 and 2316. A butt joint 2317 is formed between the ends 2318, 2320 of the duct liner 10. The portions 28 of the facing 14 on the lateral edges 16 engage one another. No portion of the insulation layer 12 is exposed to the airflow through the duct assembly. The strips 26 and/or the uncovered portion 30 may be secured to the duct housing 900 in an exemplary embodiment.

FIGS. 24A-24D and 25 illustrate an exemplary embodiment where pieces 2500 of duct liner 10 are secured to L-shaped sheetmetal panels 1302. The pieces 2500 may be applied to the sheetmetal panels 1302, before or after the panels are bent into the L-shape. Referring to 25, two L-shaped sheetmetal panels with attached duct liner 10 are assembled together to form a duct section 2400. In other embodiments, the duct housing section 2400 is formed from more or less sheetmetal panels. For example, the duct housing section 2400 may be formed from a single piece of sheetmetal.

In the example illustrated by FIGS. 24A-24D and 25, the leading and trailing ends 2402, 2404 having edge surfaces 16, 18 that are entirely covered by the facing 14. This protects the leading and trailing edge surfaces 16, 18 from high velocity airflow that is substantially normal to the edge surfaces 16.18. As such, this wrapping of the edge surfaces 16, 18 at the leading and trailing edges 2402, 2404 eliminates the need to install a metal nosing on the leading edge surface 16 facing the air stream when velocity exceeds 4000 FPM. Duct sections 2400 can be assembled in an end to end relationship to form an elongated duct assembly. When the sections are assembled, the wrapped edge surfaces 16, 18 may be brought into abutment. Since the edge surfaces 16, 18 are completely covered by the facing 14, no coating is needed on the surfaces 16, 18.

Referring to FIG. 24A, in one exemplary embodiment optional fasteners 908, 1100 are used to secure to the liner 10 to the duct housing section 2400. The fasteners 908 each extend through one of the strips 26 of the facing 14, through the insulation layer 12, and through the central portion 36 of the facing 14 that is disposed on the first face 20 of the insulation layer. The fasteners 1100 each extend through the insulation layer 12, and through the central portion 36 of the facing 14 that is disposed on the first face 20 of the insulation layer, but do not extend through one of the strips 26 of the facing 14. This arrangement securely attaches both the two ends of the duct liner 10 and the uncovered portion 30 of the duct liner 10 to the duct housing 900. The strips 26 and/or the uncovered portion 30 may also (or in the alternative) be adhered to the interior surface 904 of the duct housing 900 by an adhesive.

The fasteners 1100, 908 can be spaced with respect to the duct housing 900 and with respect to one another as described in the previous examples. In the example exemplary embodiment, the fasteners 908 are spaced from the leading and trailing ends 2402, 2404 such that the fasteners 908 extend through the strips 24. For example, the strips 24 may be 3-4 inches wide and the fasteners may be about 2 inch from the leading and trailing edges 2402, 2404. However, any strip width and spacing may be selected.

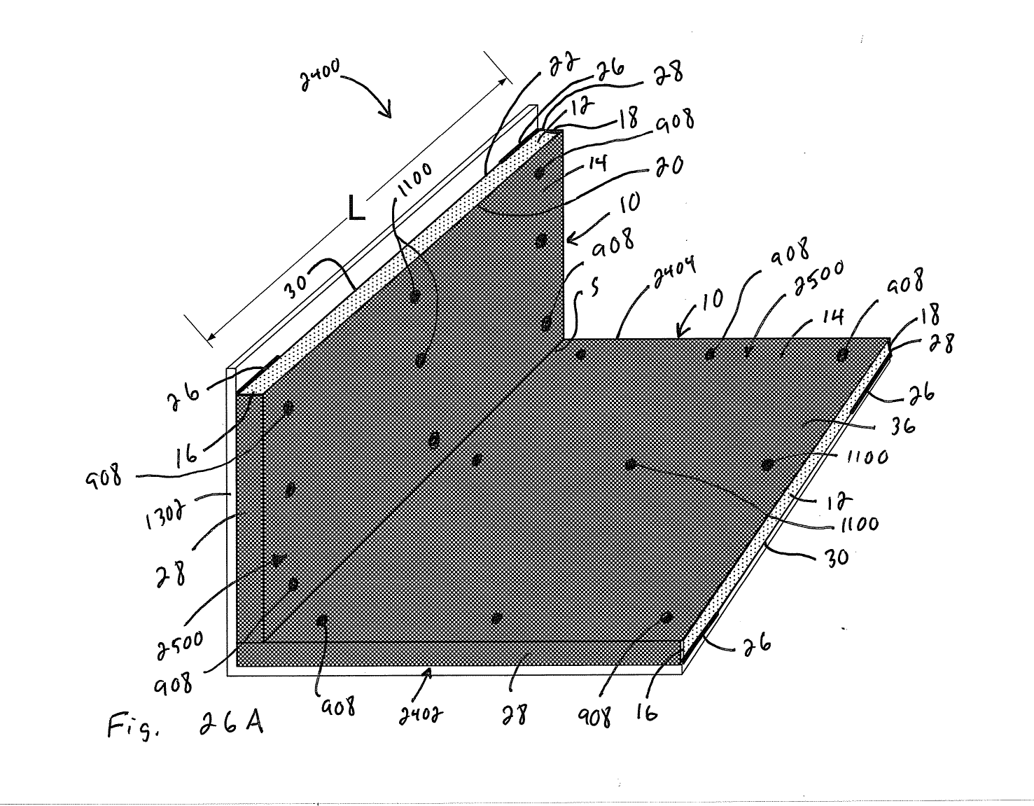

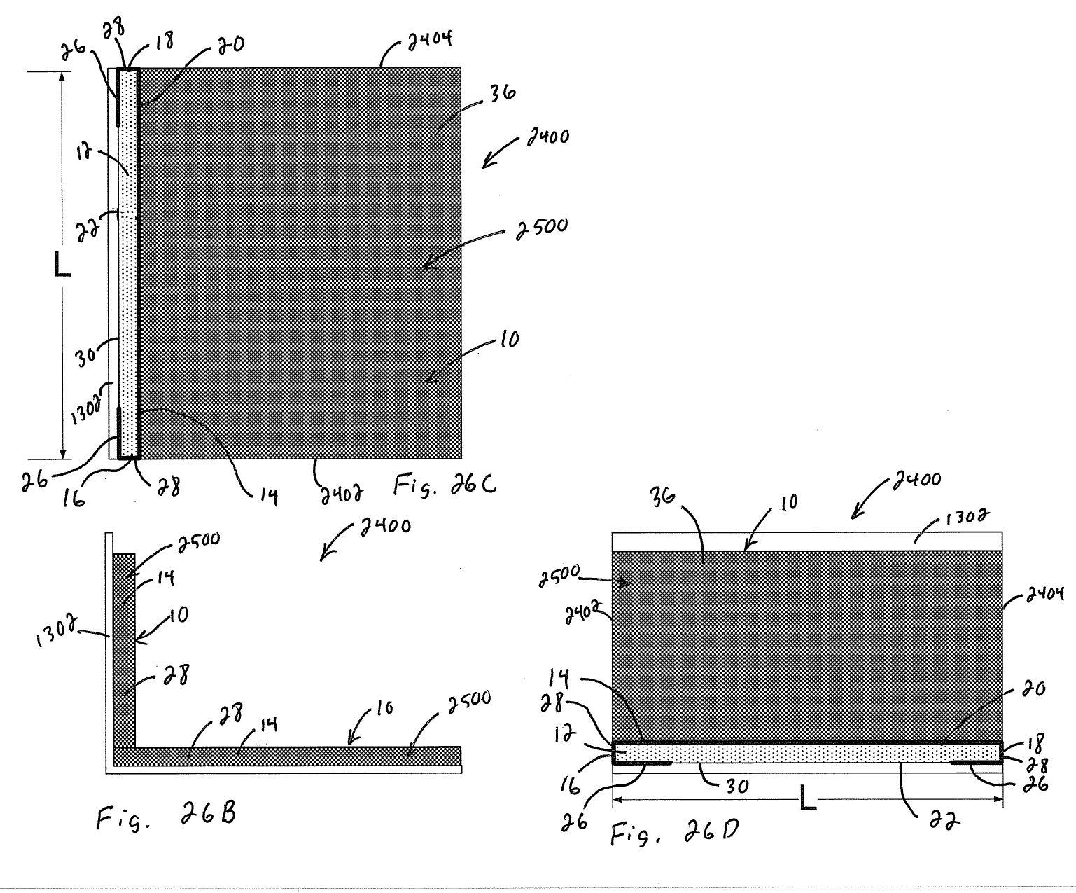

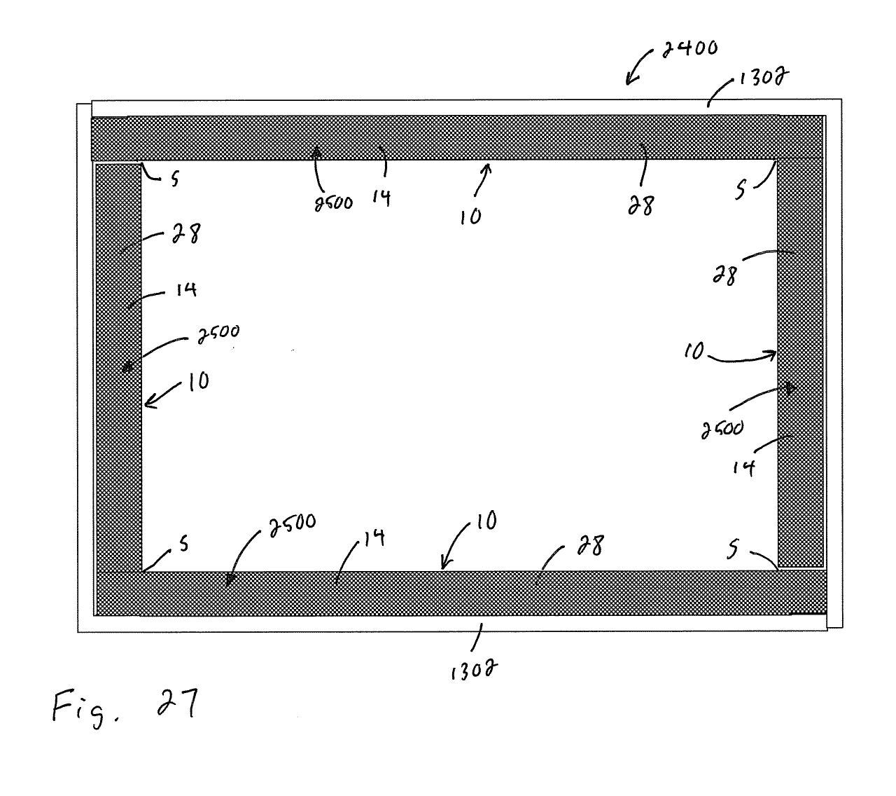

FIGS. 26A-26D illustrate an exemplary embodiment that is similar to the embodiment illustrated by FIGS. 24A-24D and 25, except two pieces 2500 of duct liner 10 are secured to each of the L-shaped sheetmetal panels 1302. The pieces 2500 may be applied to the sheetmetal panels 1302, before or after the panels are bent into the L-shape. Referring to 27, two L-shaped sheetmetal panels with attached duct liner 10 are assembled together to form a length of duct assembly 2400. In other embodiments, the duct housing 900 is formed from more or less sheetmetal panels. For example, the duct housing 900 may be formed from a single piece of sheetmetal.

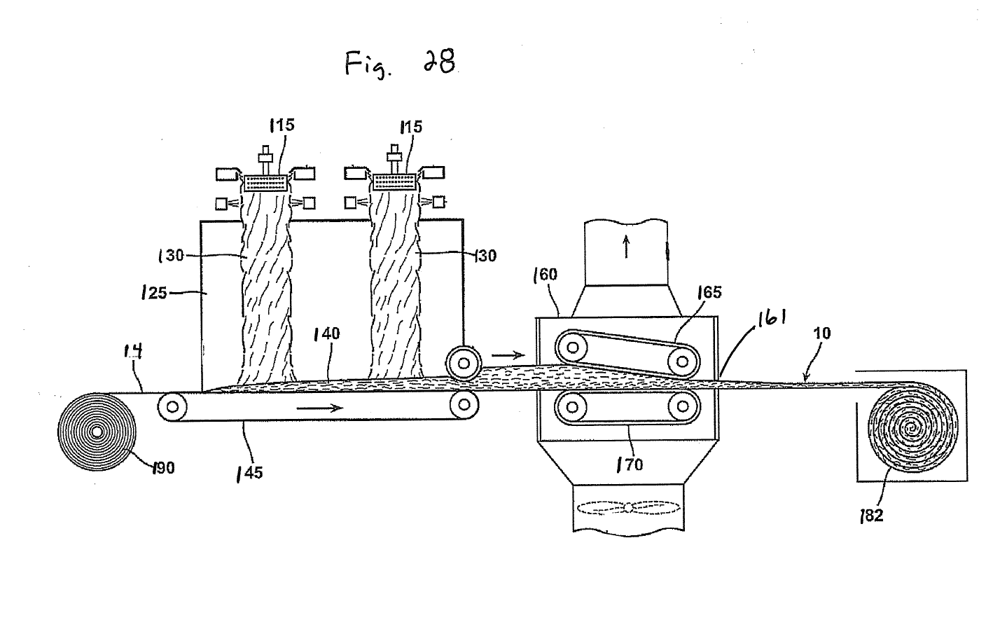

In the example illustrated by FIGS. 26A-26D and 27, the leading and trailing ends 2402, 2404 having edge surfaces 16, 18 that are entirely covered by the facing 14. This protects the leading and trailing edge surfaces 16, 18 from high velocity airflow that is substantially normal to the edge surfaces 16.18. Duct sections 2400 can be assembled in an end to end relationship to form an elongated duct assembly. When the sections are assembled, the wrapped edge surfaces 16, 18 may be brought into abutment. Since the edge surfaces 16, 18 are completely covered by the facing 14, no coating is needed on the surfaces 16, 18.

Referring to FIG. 26A, in one exemplary embodiment optional fasteners 908, 1100 are used to secure to the liner 10 duct housing 900. The fasteners 908 each extend through one of the strips 26 of the facing 14, through the insulation layer 12, and through the central portion 36 of the facing 14 that is disposed on the first face 20 of the insulation layer. The fasteners 1100 each extend through the insulation layer 12, and through the central portion 36 of the facing 14 that is disposed on the first face 20 of the insulation layer, but do not extend through one of the strips 26 of the facing 14. This arrangement securely attaches both the two ends of the duct liner 10 and the uncovered portion 30 of the duct liner 10 to the duct housing 900. The strips 26 and/or the uncovered portion 30 may also (or in the alternative) be adhered to the interior surface 904 of the duct housing 900 by an adhesive.

The fasteners 1100, 908 can be spaced with respect to the duct housing 900 and with respect to one another as described in the previous examples. In the example exemplary embodiment, the fasteners 908 are spaced from the leading and trailing ends 2402, 2404 such that the fasteners 908 extend through the strips 24. For example, the strips 24 may be 3-4 inches wide and the fasteners may be about 2 inch from the leading and trailing edges 2402, 2404. However, any strip width and spacing may be selected.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Still further, while rectangular components have been shown and described herein, other geometries can be used including elliptical, polygonal (e.g., square, triangular, hexagonal, etc.) and other shapes can also be used. Therefore, the invention, in its broader aspects, is not limited to the specific details, the representative apparatus, and illustrative examples shown and described. Accordingly, departures can be made from such details without departing from the spirit or scope of the applicant's general inventive concept.

1-47. (canceled)

48. A duct assembly comprising:
a first duct housing extending in a longitudinal direction and having an interior surface, an exterior surface, and a trailing end;
a second duct housing extending in a longitudinal direction and having an interior surface, an exterior surface, and a leading end;
a first duct liner secured to the interior surface of the first duct housing, wherein the first duct liner comprises:
an insulation layer having a leading edge surface, a trailing edge surface that is spaced apart from the leading edge surface, a first face surface that extends from the leading edge surface to the trailing edge surface, a second face surface that is opposed to and spaced apart from the first face surface and that extends from the leading edge surface to the trailing edge surface, a first lateral edge surface that extends from the leading edge surface to the trailing edge surface, and a second lateral edge surface that is opposite the first lateral edge surface and that extends from the leading edge surface to the trailing edge surface;
a facing disposed on the first face surface, such that the first face surface is entirely covered by the facing, and is disposed on the leading edge surface and the trailing edge surface, such that the leading edge surface and the trailing edge surface are entirely covered by the facing, and wherein two spaced apart strips of the facing are disposed on and cover a portion of the second face surface adjacent to the leading and trailing edges, such that a portion of the second face surface between the strips is uncovered by the facing;
a second duct liner secured to the interior surface of the second duct housing, wherein the second duct liner comprises:
an insulation layer having a leading edge surface, a trailing edge surface that is spaced apart from the leading edge surface, a first face surface that extends from the leading edge surface to the trailing edge surface, a second face surface that is opposed to and spaced apart from the first face surface and that extends from the leading edge surface to the trailing edge surface, a first lateral edge surface that extends from the leading edge surface to the trailing edge surface, and a second lateral edge surface that is opposite the first lateral edge surface and that extends from the leading edge surface to the trailing edge surface;
a facing disposed on the first face surface, such that the first face surface is entirely covered by the facing, and disposed on the leading edge surface and the trailing edge surface, such that the leading edge surface and the trailing edge surface are entirely covered by the facing, and wherein two spaced apart strips of the facing are disposed on and cover a portion of the second face surface adjacent to the leading and trailing edges, such that a portion of the second face surface between the strips is uncovered by the facing;
wherein the first duct housing and second duct housing are assembled in an end-to-end relationship such that the trailing end of the first duct housing is attached to the leading end of the second duct housing and the facing on the trailing edge surface of the first duct liner abuts the facing on the leading edge surface of the second duct liner.

49. The duct assembly of claim 48 wherein the facing on the first duct liner is disposed on the first lateral edge surface and the second lateral edge surface, such that the first and second lateral edge surfaces are entirely covered by the facing and two spaced apart strips of the facing are disposed on and cover a portion of the second face surface adjacent to the first lateral edge surface and the second lateral edge surfaces.

50. The duct assembly of claim 48 wherein one or more of the spaced apart strips of the facing are secured to the duct housing with a fastener.

51. The duct assembly of claim 50 wherein the fastener is secured to the duct housing, the fastener extends through one of the strips of the facing, the fastener extends through the insulation layer, and the fastener extends through the facing that is disposed on the first face of the insulation layer.

52. The duct assembly of claim 48 wherein the strips of the facing are secured to the duct housing with an adhesive.

53. The duct assembly of claim 48 wherein the strips of the facing are secured to the duct housing with an adhesive and a fastener that is secured to the duct housing, the fastener extends through one of the strips of the facing, the fastener extends through the insulation layer, and the fastener extends through the facing that is disposed on the first face of the insulation layer.

54. The duct assembly of claim 48 wherein the insulation layer is made from a fibrous material.

55. The duct assembly of claim 48 wherein the insulation layer is made from a material selected from the group consisting of foam, including plastic foam and rubber foam, honeycomb composites, rockwool, ceramic fibers, glass fibers, aerogels, vermiculite, calcium silicate, fiberglass matrix, polymeric fibers, composite pre-forms, cellulose, wood, and plastic.

56. The duct assembly of claim 48 wherein the facing is adhered to the insulation layer.

57. The duct assembly of claim 56 wherein the strips are adhered to the second face surface.

58. The duct assembly of claim 56 wherein the facing is adhered to the leading edge surface and the trailing edge surface of the insulation layer.

59. The duct assembly of claim 56 wherein the strips are adhered to the second face surface and the facing is adhered to the leading edge surface and the trailing edge surface of the insulation layer.

60. The duct assembly of claim 56 wherein the facing is adhered to the insulation layer with an adhesive.

61. The duct assembly of claim 60 wherein said adhesive is selected from the group consisting of formaldehyde free binder, water base adhesive, one part adhesive, two part adhesive, powder adhesive, hot melt adhesive, thin film adhesives, and spunbond hot melt adhesive webs.

62. The duct assembly of claim 56 wherein the facing is adhered to the insulation layer by ultrasonic welding.

63. The duct assembly of claim 56 wherein the facing is adhered to the insulation layer by mechanical fasteners.

64. The duct assembly of claim 48 wherein the facing is a single sheet of material.

65. The duct assembly of claim 48 wherein the facing comprises multiple sheets of material.

66. The duct assembly of claim 65 wherein the facing is prefolded such that the facing includes a predefined central portion that covers the first face surface, a pair of predefined edge covering portions on opposite sides of the predefined central portion, and the pair of strips are predefined and extend from the pair of predefined edge covering portions.
